(19) United States
(12) Patent Application Publication
(10) Pub. No.: US 2026/0364777 A1
(43) Pub. Date: Nov. 19, 2026

(54) WEARABLE APPARATUS FOR ESTIMATING INTERNAL HUMAN PHYSIOLOGICAL STATE USING DEEP LEARNING

(71) Applicant: Georgia Tech Research Corporation, Atlanta, GA (US)

(72) Inventors: Aaron Young, Atlanta, GA (US); Ryan Casey, Atlanta, GA (US); Greg Sawicki, Atlanta, GA (US)

(21) Appl. No.: 19/210,975

(22) Filed: May 16, 2025

(51) Int. Cl. B25J 9/00; B25J 9/16; B25J 13/08; B25J 19/02; G06F 3/01

(52) U.S. Cl. CPC B25J 9/0006; B25J 9/161; B25J 9/1674; B25J 13/088; B25J 19/02; G06F 3/015

(57) ABSTRACT

An exemplary system and method are disclosed that provides real-time estimates of joint moments, muscle states, and internal joint loading to facilitate injury risk profiling and biofeedback using (i) sensors integrated into a bodysuit configured to conform to a user's body and (ii) a trained deep-learning model for measuring and characterizing upper-body and lower-body biomechanics of the user in real-world scenarios with high accuracy. Data from these sensors can be processed by a microprocessor (i.e., controller) integrated into the bodysuit or in a small backpack unit, which can output various human physiological states using the deep-learning model trained on extensive datasets. The exemplary system and method can also integrate with exoskeletons or prostheses, providing a comprehensive control suite.

### GOVERNMENT LICENSE RIGHTS

This invention was made with government support under DE-NA0003525, awarded by the National Nuclear Security Administration, and 2233164, awarded by the National Science Foundation. The government has certain rights in the invention.

### BACKGROUND

An exoskeleton suit is a wearable device that can enhance or augment a user's strength and performance, allowing them to complete certain tasks or to rehabilitate their body. Examples of exoskeleton suits include assistive limbs, e.g., for Parkinson's patients or mechanical vests for warehouse workers. Powered exoskeletons use electric actuators to generate movement and act as the “muscles” of the exoskeleton. Sensors located on the powered exoskeleton provide control signals for the control of the actuators. The current state-of-the-art suits and control systems are used in rehabilitation, industrial work, and virtual reality.

Kinematic-based controllers that can determine internal states and mechanisms of the user's body using physics or physiological models can be cumbersome and complex to implement.

There is a benefit to improving the wearable robot suits and associated control systems.

### SUMMARY

An exemplary deep-learning control system and method are disclosed that provide, via real-time deep learning model, real-time and high accuracy estimations of joint angle, joint moments, internal joint loading, or a combination thereof for control and operation of actuators and motors for an exoskeleton suit using a second bodysuit having mechanical physical sensors integrated therein and conformally wore by a user to be used in conjunction with the exoskeleton suit to provide body-conformable sensor measurements for use in the internal states and internal joint loading estimations. The deep-learning model is trained across a set of typical cyclic and non-cyclic human activities using (i) the mechanical physical sensors as input to the DL training, labeled with which joint angle, joint moments, internal joint loading determined from simulations (e.g., Inverse Kinematics, Inverse Dynamics, Muscle Analysis, Joint Reaction Analysis) of joint physiological states, muscle physiological states, internal loading physiological states and (ii) external environment force or displacement measurement. The deep-learning model allows direct outputs during runtime of predicted/estimated joint angle, joint moments, and internal joint loading can be determined. As used herein, “runtime” refers to the inference or classification operation of a trained AI model.

In alternative embodiments, the deep-learning model is trained across a set of typical cyclic and non-cyclic human activities using (i) the mechanical physical sensors as input to the DL training, labeled estimated joint physiological states, muscle physiological states, and internal loading physiological states derived from physics-based simulations. The deep-learning model allows direct outputs during runtime of predicted/estimated joint physiological states, muscle physiological states, and internal loading physiological states, from which joint angle, joint moments, and internal joint loading can be determined.

Because sensors situated in prior exoskeleton suit designs do not conformally move with the body of the user, they add measurement variability that has to be accounted for in a kinematic-based estimation of internal states and mechanisms of the user's body, and they reduce the accuracy of the model. The second bodysuit (also referred to as a “second skin”) in being used in combination with the exoskeleton suit provides a platform for controller sensor measurements that improve the operation of the deep-learning controller and allow for key internal states and mechanisms and kinematics (e.g., force/moment) to be determined for use in the control and operation of an exoskeleton suit.

The term “mechanical sensor” as used herein refers to sensors configured to measure dynamic mechanical motions of an object, e.g., acceleration, vibration, gravitational force, inertia (gyroscopic forces), pressure, to which mechanical change can be observed and converted to an electrical signal. Mechanical sensors can include inertia measurement units having multiple sensors configured to measure the body's specific force, angular rate, orientation, among others.

The term “cyclic human activity” refers to a repeating sequence of events or actions that occur in a regular pattern by the human body. Non-limiting examples of cyclic activities include and are not limited to walking and/or running, e.g., at different configurations (e.g., level ground walk, walking while carrying a weighted load, backward walking, toe and heel walking, inclined walking, declined walking, start ascent, stair decent, and running).

The term “non-cyclic human activity” refers to a sequence of events or actions that occur in an irregular pattern by the human body. Non-limiting examples non-cyclic activities include and are not limited to impedance action and unstructured action, where the impedance action may include at least one of standing poses, lunges, sit and stand, tug of war, medicine ball toss, step up, jump across, jump in place, life and place weight, and squats, and where the unstructured action includes at least one of start and stop, cut, step over, turn, meander, twister, push and pull recovery, calisthenics, and curb.

The exemplary controller implements a trained deep-learning model for measuring and characterizing, e.g., upper-body and lower-body biomechanics, of the user in real-world scenarios with high accuracy, e.g., to facilitate injury risk profiling and biofeedback. Data from the sensors can be processed by a microprocessor (i.e., controller) integrated into the bodysuit or in a small backpack unit provided in proximity to the bodysuit, which executes a deep-learning model to output human physiological states for control or body measurements of an exoskeleton device or prostheses.

In some embodiments, the exemplary system and method employ mechanical sensors (e.g., IMU) and pressure sensors (e.g., pressure insole) configured to provide measurement of a user's movements for joint state estimation with high accuracy in real time. Current state-of-the-art wearable systems for calculating joint states employ various analytical methods (e.g., measurement via strain sensors and IMUs for kinematic sensing and EMG-driven forward dynamics for joint moment tracking), but these methods can experience high variability in EMG data or poor generalization to new tasks and users. The combination of IMUs and pressure insoles provides more precise and accurate measurements than the analytical methods, so the exemplary system and method are better than the current state-of-the-art systems in providing real-time estimates of joint moments, muscle states, and internal joint loading.

In an aspect, a system is disclosed comprising a bodysuit configured to wrap around and conform to a body region of a user, the bodysuit being instrumented with a plurality of mechanical sensors, including (i) a first sensor placed at a first non-joint body appendage and (ii) a second sensor placed at a second non-joint body appendage; and a controller including a processor; a memory having instructions stored thereon, wherein execution of the instructions by the processor causes the processor to: receive, via the processor, sensor data measurements acquired from the plurality of mechanical sensors; determine, via a trained deep-learning model, physiological state estimates, physical state estimates, or a combination thereof using the sensor data measurements, including of the first sensor and the second sensor, as input to the trained deep-learning model, wherein the physiological state estimates, physical state estimates, or a combination thereof are directed to joint region located between the first non-joint body appendage and the second non-joint body appendage; and output, via the processor, the physiological state estimates, the physical state estimates, or the combination thereof, wherein the output is used for controls, biofeedback, or monitoring of the user or user activity.

In some embodiments, the physiological state estimates include joint-level physiological states selected from the group consisting of joint kinematics (e.g., angles and velocities), segment kinematics, joint moments, joint powers, and joint mechanical works.

In some embodiments, the physiological state estimates include muscle-level physiological states selected from the group consisting of muscle length/velocity, muscle force, muscle applied torque, and muscle power.

In some embodiments, the physiological state estimates include internal-joint-loading physiological states selected from the group consisting of bone-on-bone contact force and shear forces at joints.

In some embodiments, the physical state estimates include ground reaction forces made by feet or hands making mechanical contact with a surface.

In some embodiments, a trained deep-learning model was trained using a plurality of sensor data measurements acquired at a set of body segments proximal to a set of joints (e.g., elbows, knees, pelvis, back) labeled with joint-level physiological states (e.g., joint kinematics, segment kinematics, joint moments, joint powers, joint mechanical work) for a plurality of activities (e.g., cyclic and non-cyclic human activities) performed by a set of people.

In some embodiments, the trained deep-learning model was trained using a plurality of sensor data measurements acquired at a set of body segments proximal to or at a set of muscles (e.g., at arms, legs, thighs) labeled with muscle-level physiological states (e.g., muscle length/velocity, muscle force, muscle applied torque, muscle power) for a plurality of cyclic and non-cyclic human activities performed by a set of people.

In some embodiments, the trained deep-learning model was trained using a plurality of sensor data measurements acquired at a set of body segments proximal to a set of joints (e.g., elbows, knees, pelvis, back) labeled with internal-joint-loading physiological states (e.g., bone-on-bone contact force, shear forces at the joints) for a plurality of cyclic and non-cyclic human activities performed by a set of people.

In some embodiments, the trained deep-learning model was trained using a plurality of sensor data measurements acquired at a set of feet labeled with physical states (e.g., ground reaction forces) for a plurality of cyclic and non-cyclic human activities performed by a set of people.

In some embodiments, each mechanical sensor of the plurality of mechanical sensors is an inertial measurement unit (IMU) (i) placed at a region of a body appendage or muscle and (ii) configured to generate acceleration data measurements, angular velocity data measurements, orientation data measurements, or a combination thereof acquired at the region of the body appendage or muscle.

In some embodiments, each mechanical sensor of the plurality of mechanical sensors is an accelerometer (i) placed at region of a body appendage or muscle and (ii) configured to generate acceleration data measurements, angular velocity data measurements, orientation data measurements, or a combination thereof acquired at the region of the body appendage or muscle.

In some embodiments, each mechanical sensor includes a gyroscope (i) placed at a region of a body appendage or muscle and (ii) configured to generate acceleration data measurements, angular velocity data measurements, orientation data measurements, or a combination thereof acquired at the region of the body appendage or muscle.

In some embodiments, the bodysuit is configured to cover a lower-body region of the user, including at least one leg, a thigh, a pelvic region, and a knee (e.g., may additionally include at least a foot).

In some embodiments, the bodysuit is configured to cover upper-body parts, including at least one arm, an elbow, and chest (e.g., may additionally include wrist or palm).

In some embodiments, the system described herein (e.g., for a training system) further comprises a set of pressure sensors (e.g., for foot or hands) configured to generate surface reaction force data measurements, center-of-pressure measurements, or a combination thereof, acquired from feet or hands/fingers.

In some embodiments, execution of the instructions by the processor further causes the processor to determine, via the trained deep-learning model, physiological state estimates, physical state estimates, or a combination thereof using the surface reaction force data measurements, the center-of-pressure measurements, or the combination thereof as input to the trained deep-learning model; and output, via the processor, the physiological state estimates, the physical state estimates, or the combination thereof for use in controls or monitors of the bodysuit.

In some embodiments, the set of pressure sensors is placed on the feet.

In some embodiments, the set of pressure sensors is placed on the hands/fingers.

In some embodiments, the physiological state estimates, the physical state estimates, or the combination thereof is subsequently employed for health or safety-related monitoring of activities or tasks performed by the user.

In some embodiments, the physiological state estimates, the physical state estimates, or the combination thereof is subsequently employed for generating biofeedback reports or alerts for activities performed by the user.

In some embodiments, the physiological state estimates, the physical state estimates, or the combination thereof is subsequently employed for controlling an exoskeleton or robot.

In some embodiments, the controller is implemented in a backpack including: a battery; and a plurality of cable channels configured to provide wired connections between the mechanical sensors and the controller.

In some embodiments, the controller is implemented in a mobile device (e.g., tablet, smartphone), including a network interface configured to communicate with the mechanical sensors through a network.

In some embodiments, the controller is a remote computing device located in a cloud infrastructure, including a network interface configured to communicatively operate with the mechanical sensors through a network.

In some embodiments, the trained deep-learning model is a temporal neural network (e.g., musculoskeletal model).

In some embodiments, the cyclic and non-cyclic human activities include a plurality of motions selected from the group consisting of walking, standing, pushing, pulling, shoveling, turning, cutting, sitting, jumping, ball tossing, lifting a weight, stepping up, and climbing stairs, and wherein each cyclic and non-cyclic human activity is performed at different configurations (e.g., ground-level, forward, backward, etc.)

In another aspect, a method is disclosed comprising providing a bodysuit configured to wrap around and conform to a body region of a user, the bodysuit being instrumented with a plurality of mechanical sensors, including (i) a first sensor placed at a first non-joint body appendage and (ii) a second sensor placed at a second non-joint body appendage; receiving, via a processor, sensor data measurements acquired from the plurality of mechanical sensors placed at a plurality of non-joint body appendages of a user; determining, via a trained deep-learning model, physiological state estimates, physical state estimates, or a combination thereof using the sensor data measurements, including the first sensor and the second sensor, as input to the trained deep-learning model, wherein the physiological state estimates, physical state estimates, or a combination thereof are directed to a joint region located between the first non-joint body appendage and the second non-joint body appendage; and outputting, via the processor, the physiological state estimates, the physical state estimates, or the combination thereof, wherein the output is used for controls, biofeedback, or monitoring of the user or user activity.

In some embodiments, the trained deep-learning model was trained using a plurality of sensor data measurements acquired at a set of body segments proximal to a set of joints (e.g., elbows, knees, pelvis, back) labeled with joint-level physiological states (e.g., joint kinematics, segment kinematics, joint moments, joint powers, joint mechanical work) for a plurality of activities (e.g., cyclic and non-cyclic human activities) performed by a set of people.

In some embodiments, the trained deep-learning model was trained using a plurality of sensor data measurements acquired at a set of body segments proximal to or at a set of muscles (e.g., at arms, legs, thighs) labeled with muscle-level physiological states (e.g., muscle length/velocity, muscle force, muscle applied torque, muscle power) for a plurality of cyclic and non-cyclic human activities performed by a set of people.

In some embodiments, the trained deep-learning model was trained using a plurality of sensor data measurements acquired at a set of body segments proximal to a set of joints (e.g., elbows, knees, pelvis, back) labeled with internal-joint-loading physiological states (e.g., bone-on-bone contact force, shear forces at the joints) for a plurality of cyclic and non-cyclic human activities performed by a set of people.

In some embodiments, the trained deep-learning model was trained using a plurality of sensor data measurements acquired at a set of feet labeled with physical states (e.g., ground reaction forces) for a plurality of cyclic and non-cyclic human activities performed by a set of people.

### BRIEF DESCRIPTION OF DRAWINGS

FIGS. 1A-1E each shows an example deep-learning control system configured with a body-conformable bodysuit instrumented with a plurality of mechanical sensors to be used in conjunction with the exoskeleton suit and to determine predicted/estimated joint angle, joint moments, internal joint loading for control or monitoring, in accordance with an illustrative embodiment.

FIG. 2 shows an example bodysuit to be used in combination with the exoskeleton suit to provide for controller sensor measurements in the exemplary system in accordance with an illustrative embodiment.

FIGS. 3A-3C show example joint angles and moments that can be determined using the trained deep-learning model controller of FIGS. 1A-1E in accordance with an illustrative embodiment.

FIG. 4 shows an example operation flow of the exemplary system in accordance with an illustrative embodiment.

FIGS. 5A-5D each show a view of an example backpack plate on which the controller of the exemplary system of FIGS. 1A-1E can be mounted in accordance with an illustrative embodiment.

FIG. 6 shows an example system diagram for the controller of FIGS. 1A-1E in accordance with an illustrative embodiment.

FIG. 7 shows an example bodysuit that can be used with the controller of FIGS. 1A-1E in accordance with an illustrative embodiment.

FIG. 8 shows an example wearable exoskeleton system employing the bodysuit and exoskeleton suit of FIGS. 1A-1E in accordance with an illustrative embodiment.

FIG. 9 shows an example deep-learning neural network of FIGS. 1A-1E in accordance with an illustrative embodiment.

FIGS. 10A-10D show experimental results of a study conducted to develop and evaluate a participant-independent, task-agnostic approach for estimating joint angle and moment at the lower back, hip, knee, and ankle, e.g., using the exemplary system and method described herein.

FIGS. 11A-11D show experimental results of a system and trained deep-learning model of anther aspect of the study conducted to develop a deep learning system that can directly estimate internal joint and muscle level physiological states of the lower limb for a wide range of cyclic and noncyclic activities, e.g., using the exemplary system and method described herein.

FIGS. 12A-12F shows experimental results of a system and trained deep-learning model of another aspect of the study conducted to estimate joint contact forces (JCFs) in the knee during dynamic and manual labor tasks, e.g., using the exemplary system and method described herein.

### DETAILED DESCRIPTION

Some references, which may include various patents, patent applications, and publications, are cited in a reference list and discussed in the disclosure provided herein. The citation and/or discussion of such references is provided merely to clarify the description of the disclosed technology and is not an admission that any such reference is “prior art” to any aspects of the disclosed technology described herein. In terms of notation, “[n]” corresponds to the n^{th} reference in the list. For example, [1] refers to the first reference in the list. All references cited and discussed in this specification are incorporated herein by reference in their entirety and to the same extent as if each reference was individually incorporated by reference.

### Example System

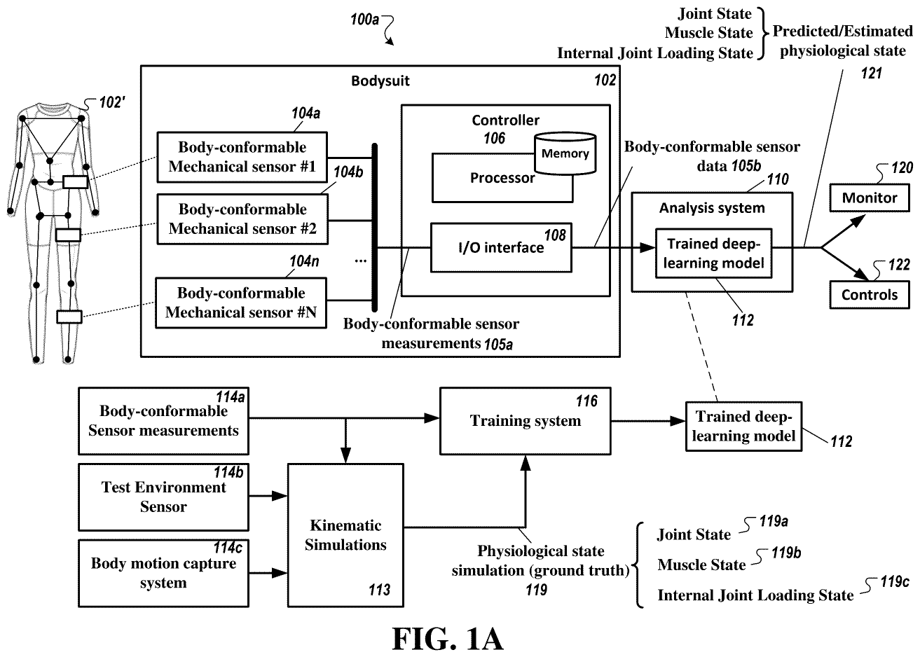

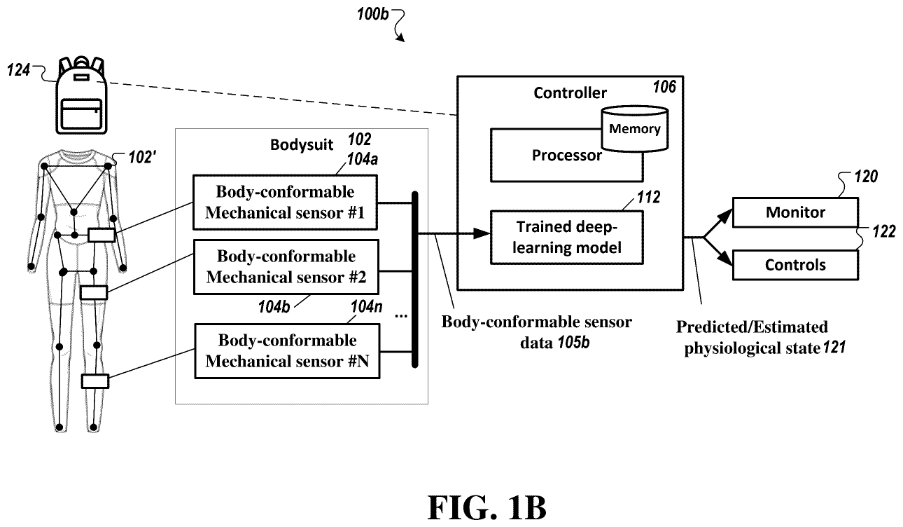

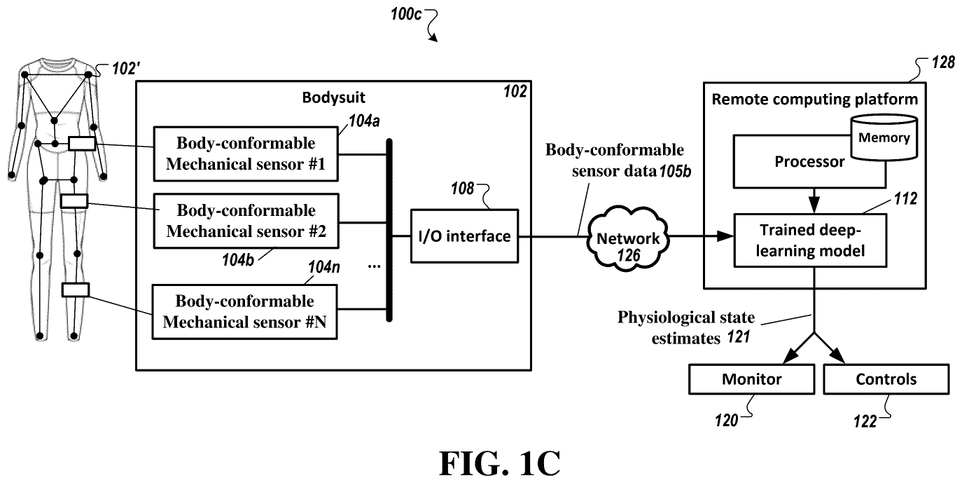

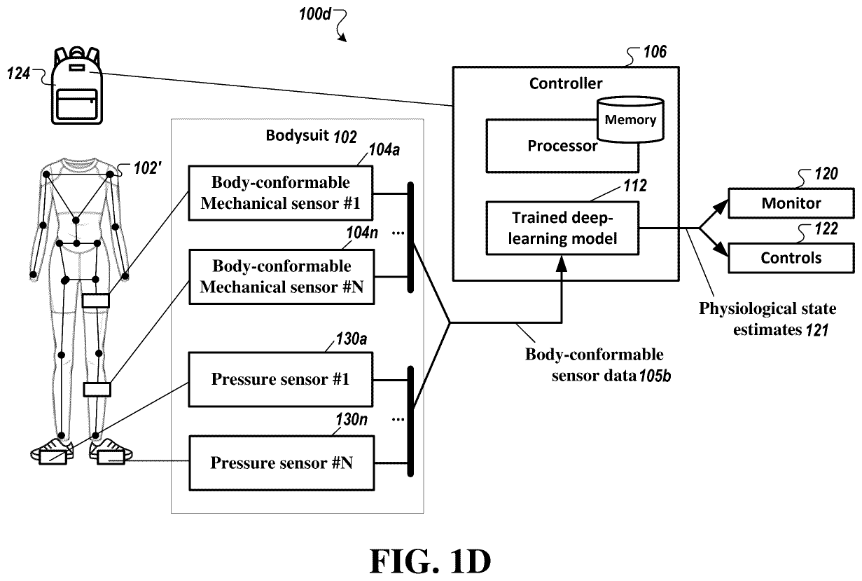

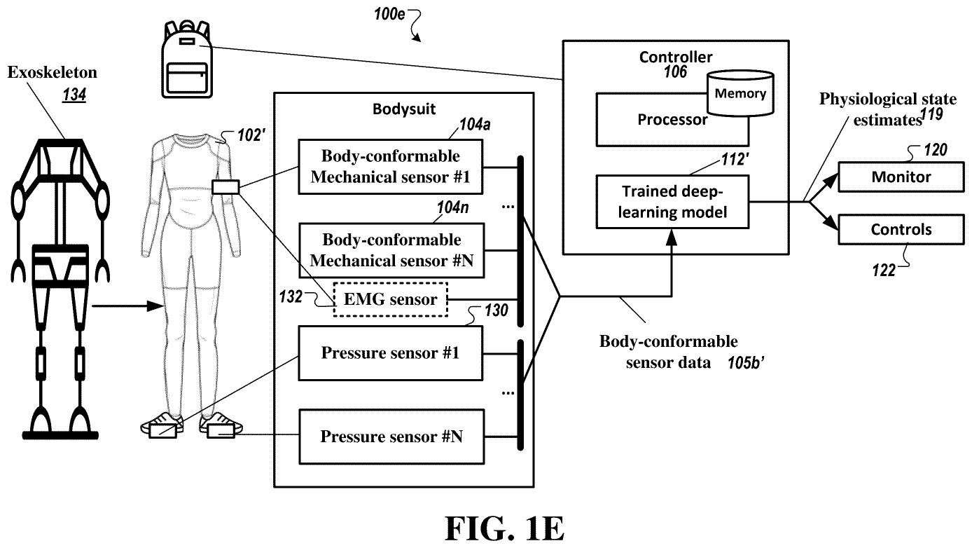

FIGS. 1A-1E each shows an example deep-learning control system 100 (shown as 100a, 100b. 100c, 100d, and 100e) configured with a body-conformable bodysuit 102 (shown as 102′) instrumented with a plurality of mechanical sensors 104 (shown as 104a, 104b, . . . , 104n) to be used in conjunction with the exoskeleton suit (see, e.g., FIG. 1E) and to determine predicted/estimated joint angle, joint moments, internal joint loading for control or monitoring, in accordance with an illustrative embodiment.

In FIGS. 1A-1E, the example deep-learning control system (e.g., 100a-100e) each includes a controller 106 and a trained deep-learning model 112 (shown as 112′). FIG. 1A additionally shows a training system 116 configured to train the deep-learning model as well as the runtime platform. FIG. 1B shows an example implementation of the controller 106 configured as a local controller, e.g., executing as a backpack 124. FIG. 1C shows an example implementation of the controller 106 as a remote computing device 128 (shown as a remote computing platform) located in a cloud infrastructure comprising a network interface configured to communicatively operate with the mechanical sensors 104 through a network 126. FIG. 1D further employs a plurality of pressure sensors 130 (shown as 130a, . . . , 130n). FIG. 1E further employs an exoskeleton 134 (see, e.g., FIG. 1E) integrated into the bodysuit 102′.

In the examples shown in FIGS. 1A-1E, the bodysuit 102 (shown as 102′) is configured to wrap around and conform to a body region of a user. The bodysuit is instrumented with a plurality of mechanical sensors 104 (shown as 104a, 104b, . . . , 104n), e.g., a first sensor fixably placed at (i) a first non-joint body appendage and (ii) a second sensor placed at a second non-joint body appendage to which joint kinematics at the joint between the first non-joint body appendage and the second non-joint body appendage can be ascertained. The bodysuit 102 can be configured to cover the lower-body region of the user with conformable body sensors at neighboring regions over a joint, e.g., at the lower leg (calf/shin) and the upper leg (e.g., thigh) to provide measure of the knee, at the upper leg and the pelvis to provide measure of the hip movement/rotation, at the foot and the lower leg to provide measure of the ankle. The bodysuit 102 can also be configured with conformable body sensors at neighboring regions over a joint, e.g., at the upper shoulder and the upper arm to provide a measure of the shoulder joint, at the upper arm and the lower arm (e.g., forearm) to provide a measure of the elbow joint, at a lower arm and the hand to provide a measure of the wrist, and at the upper chest and stomach to provide measure of the torso movement/rotation.

Each mechanical sensor 104 (shown as “Body-conformable Mechanical Sensor” 104a, 104b, . . . , 104n) may be an inertial measurement unit (IMU), e.g., comprising a multi-axis accelerometer and gyroscope to generate acceleration data measurements, angular velocity data measurements, orientation data measurements, or a combination thereof acquired at the segment region of the body appendage. The mechanical sensor 104 is lightweight and is preferably woven or stitched to the bodysuit 102 to be fixably attached to a bodysuit 102 to provide a conformable sensor fit to the body that moves in direct correspondence with the body movement and without any play or variability.

The controller 106 includes an input/output (I/O) interface 108 configured to receive the body-conformable sensor measurements 105a acquired from the plurality of body-conformable mechanical sensors 104. The controller 106, via the input/output (I/O) interface 108, is also configured to condition, filter, and convert the measurements 105a to measurement data 105b to provide to an analysis system 110.

The analysis system 110 includes a trained deep-learning model 112 configured to determine/estimate/predict joint angle, joint moments, internal joint loading, or other physiological states from the body-conformable sensor measurement data 105b. The trained deep-learning model 112 has been trained across a set of typical cyclic and non-cyclic human activities using body-conformable mechanical physical sensor measurements 105a as input to the deep learning training, labeled with internal physiological state of the joint, e.g., joint angle, joint moments, velocity, force, internal joint loading (e.g., bone-on-bone contact load, shear stress on joints, etc.), joint power, etc., determined from kinematic simulations 113.

Example kinematic simulations 113 include and are not limited to Inverse Kinematics analysis, Inverse Dynamics analysis, Muscle Analysis, Joint Reaction Analysis). The simulations 113 employ inputs from (i) body-conformable mechanical physical sensor measurements 114 acquired from worn sensors while a test person is performing cyclic and non-cyclic human activities in combination with (ii) body motion capture measurements 114c (e.g., via a motion capture system) and (iii) force measurements 114b (e.g., captured via external force or displacement sensors in a test environment or wearable sensors, e.g., with insole force sensors).

The output 121 of the trained AI model 112 can provide predicted/estimated physiological state, e.g., joint state, joint forces, internal joint loading state, and the like. The output 121 can be used for the control and/operation of actuators and motors for an exoskeleton suit. In some embodiments, the output 121 is provided in a report, e.g., a graphical user interface or physical report, e.g., for diagnosis. In some embodiments, the output 121 is subjected to additional analysis.

In some embodiments, the trained deep-learning model 112 is implemented in a local computing device, e.g., that can be put into a backpack (e.g., 124, see FIG. 1B). In some embodiments, the trained deep-learning model 112 is implemented in a remote server, e.g., in cloud infrastructure (see FIG. 1C). In FIG. 1C, the sensors 104 may be configured to operate with a local controller that can communicate (e.g., data 105b) with the remote computing platform 128 over a network 126. The system of FIG. 1C is simplified (e.g., not showing the IO interface 108).

Pressure Sensor. FIG. 1D shows another configuration of the deep-learning control system 100d configured with a body-conformable bodysuit 102. The configuration of FIG. 1D can be implemented in combination with FIGS. 1A-1C or 1E.

In the example shown in FIG. 1D, the system 100d includes a plurality of pressure sensors 130 (shown as 130a, . . . , 130n). The pressure sensors (130a . . . 130n) are configured to measure insole pressure to provide measurements equivalent to, as a virtual measurement of, the external environment force measurements. In some embodiments, the pressure sensors are integrated into shoes and are configured to provide plantar pressure and gait data from which the insole pressure can be derived. In some embodiments, the pressure sensors 130 are configured to generate a surface reaction force data measurement, center-of-pressure measurement, or a combination thereof, acquired from feet. Similar sensors can be provided for the hands or fingers for upper extremity estimations.

Electromyographic (EMG) sensors. FIG. 1E shows another configuration of the deep-learning control system 100e configured with a body-conformable bodysuit 102. The configuration of FIG. 1E can be implemented in combination with FIGS. 1A-1D.

In the example shown in FIG. 1E, the system 100e includes one or more electromyographic (EMG) sensors 132 configured to provide EMG data measurements acquired from a region of a body appendage or muscle. The EMG data measurement may be provided to the IO interface to provide EMG data (shown as body-conformable sensor data 105b′) to the trained deep-learning model 112 (shown as 112′) or another trained AI model (not shown) configured to additionally provide muscle states (e.g., in addition to the physiological state estimates and physical state estimates described in relation to FIGS. 1A-1D).

Exoskeleton device. FIG. 1E shows the system 100 (shown as 100e) configured to operate with an exoskeleton 134 to which the bodysuit 102′ can operate in combination therewith. The exoskeleton 134 (or robot) can be controlled by the physiological state estimates, the physical state estimates, or the combination thereof (shown as 119, 119′) determined by the trained deep-learning model 112. Exoskeleton 134 can be an exoskeleton suit, powered exoskeletons, prosthetics, or other external body-augmenting devices described herein.

The exoskeleton 134 of FIG. 1E can be used in combination with the bodysuit 102 and the controller system of the system described in relation to FIGS. 1A-1D.

Trained Deep-Learning model. In the examples shown in FIG. 1A (and similarly can be implemented in FIGS. 1B-1E), the trained deep-learning model (e.g., 116) can be trained via a training system 116 (FIG. 1A) using various classes of training data, including (i) joint physiological states, (ii) muscle physiological states, (iii) internal-joint-loading physiological states, or (iv) physical states. In FIG. 1A, the trained deep-learning model 112 has been trained across a set of typical cyclic and non-cyclic human activities using body-conformable mechanical physical sensor measurements 105a as input to the deep learning training, labeled with internal physiological state of the joint, e.g., joint angle, joint moments, velocity, force, internal joint loading (e.g., bone-on-bone contact load, shear stress on joints, etc.), joint power, etc., determined from kinematic simulations 113. The input sensor data measurements 114a acquired at a set of body segments proximal to a set of joints (e.g., elbows, knees, pelvis, back) labeled with joint-level physiological state (PS) estimates 119a (e.g., joint kinematics, segment kinematics, joint moments, joint powers, joint mechanical work) for a plurality of activities (e.g., cyclic and non-cyclic human activities) maybe performed by a set of people.

In another embodiment, the trained deep-learning model (e.g., 112′) can be trained, via the training system 116, using a plurality of sensor data measurements 114a acquired at a set of body segments proximal to or at a set of muscles (e.g., at arms, legs, thighs) labeled with muscle physiological state (PS) estimates 119b (e.g., muscle length/velocity, muscle force, muscle applied torque, muscle power) for a plurality of activities performed by a set of people.

In another embodiment, the trained deep-learning model 112 can be trained, via the training system 116, using a plurality of sensor data measurements 114 acquired at a set of body segments proximal to a set of joints (e.g., elbows, knees, pelvis, back) labeled with internal-joint-loading physiological states 119c (e.g., bone-on-bone contact force, shear forces at the joints) for a plurality of activities performed by a set of people.

Cyclic and non-cyclic human activities. The cyclic and non-cyclic human activities measured to generate training data for the trained deep-learning model 112 can include walking, standing, pushing, pulling, shoveling, turning, cutting, sitting, jumping, ball tossing, lifting a weight, stepping up, and climbing stairs, among other activities described or referenced herein. Each cyclic and non-cyclic human activity can be performed for different activity and environment configurations (e.g., ground-level, forward, backward, etc.).

An example of the AI model is the temporal neural network, LSTM, RNNs, NN, transformers, though other AI models can be used. For example, the trained neural network system can be implemented, as a ML-based operation, using one or more artificial intelligence and machine learning operations. The term “artificial intelligence” can include any technique that enables one or more computing devices or computing systems (i.e., a machine) to mimic human intelligence. Artificial intelligence (AI) includes but is not limited to knowledge bases, machine learning, representation learning, and deep learning. The term “machine learning” is defined herein to be a subset of AI that enables a machine to acquire knowledge by extracting patterns from raw data. Machine learning techniques include, but are not limited to, logistic regression, support vector machines (SVMs), decision trees, Naïve Bayes classifiers, and artificial neural networks. The term “representation learning” is defined herein to be a subset of machine learning that enables a machine to automatically discover representations needed for feature detection, prediction, or classification from raw data. Representation learning techniques include, but are not limited to, autoencoders and embeddings. The term “deep learning” is defined herein to be a subset of machine learning that enables a machine to automatically discover representations needed for feature detection, prediction, classification, etc., using layers of processing. Deep learning techniques include, but are not limited to, artificial neural networks or multilayer perceptron (MLP).

An artificial neural network (ANN) is a computing system including a plurality of interconnected neurons (e.g., also referred to as “nodes”). This disclosure contemplates that the nodes can be implemented using a computing device (e.g., a processing unit and memory as described herein). The nodes can be arranged in a plurality of layers, such as an input layer, an output layer, and optionally one or more hidden layers with different activation functions. An ANN having hidden layers can be referred to as a deep neural network or multilayer perceptron (MLP). Each node is connected to one or more other nodes in the ANN. For example, each layer is made of a plurality of nodes, where each node is connected to all nodes in the previous layer. The nodes in a given layer are not interconnected with one another, i.e., the nodes in a given layer function independently of one another. As used herein, nodes in the input layer receive data from outside of the ANN, nodes in the hidden layer(s) modify the data between the input and output layers, and nodes in the output layer provide the results. Each node is configured to receive an input, implement an activation function (e.g., binary step, linear, sigmoid, tanh, or rectified linear unit (ReLU) function), and provide an output in accordance with the activation function. Additionally, each node is associated with a respective weight. ANNs are trained with a dataset to maximize or minimize an objective function. In some implementations, the objective function is a cost function, which is a measure of the ANN's performance (e.g., error such as L1 or L2 loss) during training, and the training algorithm tunes the node weights and/or bias to minimize the cost function. This disclosure contemplates that any algorithm that finds the maximum or minimum of the objective function can be used for training the ANN. Training algorithms for ANNs include, but are not limited to, backpropagation. It should be understood that an artificial neural network is provided only as an example machine learning model. This disclosure contemplates that the machine learning model can be any supervised learning model, semi-supervised learning model, or unsupervised learning model. Optionally, the machine learning model is a deep learning model. Machine learning models are known in the art and are therefore not described in further detail herein.

A convolutional neural network (CNN) is a type of deep neural network that has been applied, for example, to image analysis applications. Unlike traditional neural networks, each layer in a CNN has a plurality of nodes arranged in three dimensions (width, height, depth). CNNs can include different types of layers, e.g., convolutional, pooling, and fully-connected (also referred to herein as “dense”) layers. A convolutional layer includes a set of filters and performs the bulk of the computations. A pooling layer is optionally inserted between convolutional layers to reduce the computational power and/or control overfitting (e.g., by downsampling). A fully-connected layer includes neurons, where each neuron is connected to all of the neurons in the previous layer. The layers are stacked similarly to traditional neural networks. GCNNs are CNNs that have been adapted to work on structured datasets such as graphs.

Other Supervised Learning Models. A logistic regression (LR) classifier is a supervised classification model that uses the logistic function to predict the probability of a target, which can be used for classification. LR classifiers are trained with a data set (also referred to herein as a “dataset”) to maximize or minimize an objective function, for example, a measure of the LR classifier's performance (e.g., an error such as L1 or L2 loss), during training. This disclosure contemplates that any algorithm that finds the minimum of the cost function can be used. LR classifiers are known in the art and are therefore not described in further detail herein.

A Naïve Bayes' (NB) classifier is a supervised classification model that is based on Bayes' Theorem, which assumes independence among features (i.e., the presence of one feature in a class is unrelated to the presence of any other features). NB classifiers are trained with a data set by computing the conditional probability distribution of each feature given a label and applying Bayes' Theorem to compute the conditional probability distribution of a label given an observation. NB classifiers are known in the art and are therefore not described in further detail herein.

A k-NN classifier is an unsupervised classification model that classifies new data points based on similarity measures (e.g., distance functions). The k-NN classifiers are trained with a data set (also referred to herein as a “dataset”) to maximize or minimize a measure of the k-NN classifier's performance during training. This disclosure contemplates any algorithm that finds the maximum or minimum. The k-NN classifiers are known in the art and are therefore not described in further detail herein.

A majority voting ensemble is a meta-classifier that combines a plurality of machine learning classifiers for classification via majority voting. In other words, the majority voting ensemble's final prediction (e.g., class label) is the one predicted most frequently by the member classification models. The majority voting ensembles are known in the art and are therefore not described in further detail herein.

### Example Bodysuit

FIG. 2 shows an example bodysuit 102 to be used in combination with the exoskeleton suit to provide for controller sensor measurements in the exemplary system in accordance with an illustrative embodiment. As shown, the bodysuit 102 is configured to wrap around and conform to a body region of a user. The bodysuit can be instrumented with a plurality of mechanical sensors (e.g., 104a, 104b, . . . , 104n) placed at non-joint body appendages. The bodysuit is fabricated to conform tightly to the user's body. In other embodiments, the bodysuit can be fabricated to be loose-fitting, but it still tightly conforms to the body region at which mechanical and/or pressure sensors are disposed.

The bodysuit 102 can be configured to cover a lower-body region of the user, including at least one leg, a thigh, a pelvic region, and a knee (e.g., may include at least a foot). The bodysuit 102 can also be configured to cover upper-body parts, including at least one arm, an elbow, and a chest (e.g., may include wrist or palm). An exoskeleton can be integrated into the bodysuit and be controlled by a controller, as shown in FIG. 1E.

### Example Joint Angles and Moments

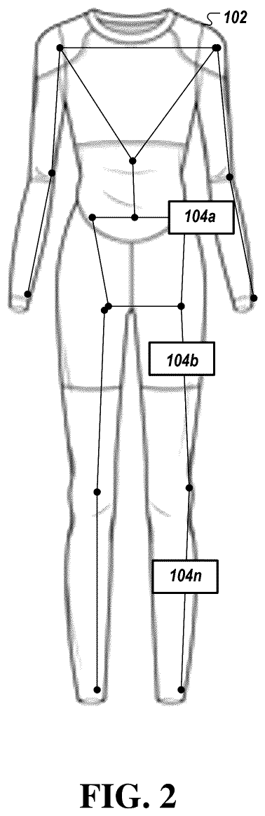

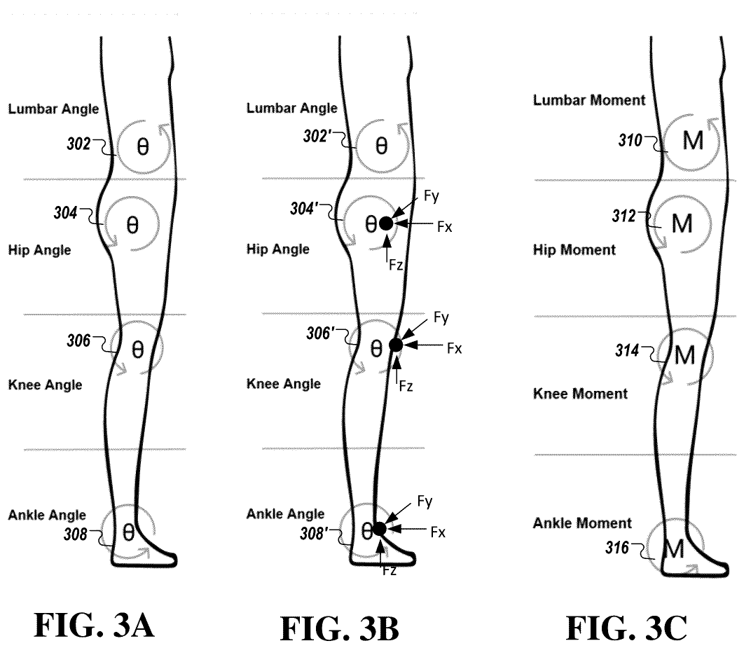

FIGS. 3A-3C show example joint angles and moments that the exemplary system and method are configured to measure to determine physiological state estimates, physical state estimates, or a combination thereof of a user (shown as 119′ in FIG. 1A), which is then used to train the deep-learning model (shown as 112 in FIGS. 1A-1D) of the exemplary system.

FIGS. 3A-3B show example lumbar angle 302 (shown as 302′), hip angle 304 (shown as 304′), knee angle 306 (shown as 306′), and ankle angle 308 (shown as 308′), where each angle can be defined by (i) three directions, including x-direction (shown as Fx), y-direction (shown as Fy), and z-direction (shown as Fz), and (ii) a rotation (e.g., clockwise and counterclockwise).

FIG. 3C shows example lumbar moment 310, hip moment 312, knee moment 314, and ankle moment 316, wherein each moment can also be defined by (i) three directions (e.g., x, y, z) and (ii) a rotation (e.g., clockwise, counterclockwise).

### Example Method

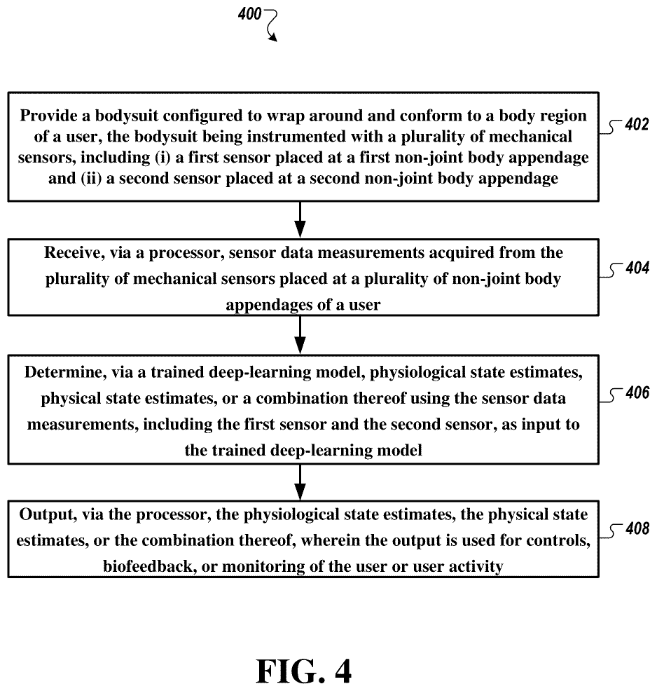

FIG. 4 shows an example operation flow 400 for the exemplary system in accordance with an illustrative embodiment. The method 400 includes providing (402) a bodysuit configured to wrap around and conform to a body region of a user, the bodysuit being instrumented with a plurality of mechanical sensors, including (i) a first sensor placed at a first non-joint body appendage and (ii) a second sensor placed at a second non-joint body appendage.

Method 400 includes receiving (404), via the processor, body-conformable sensor data measurements acquired from the plurality of mechanical sensors.

The data measurements may include ground reaction forces made by feet or hands making mechanical contact with a surface (e.g., acquired via a wearable sensor or an external sensor). The surface reaction force data measurements may include center-of-pressure measurements. The measurements may be acquired from the feet, hands/fingers, head, or other appendages, etc.

Method 400 includes determining (406), via a trained deep-learning model, physiological state estimates, physical state estimates, or a combination thereof using the body-conformable sensor data measurements, including the first body-conformable sensor and the second body-conformable sensor, as input to the trained deep-learning model, wherein the physiological state estimates, physical state estimates, or a combination thereof are directed to a joint region located between the first non-joint body appendage and the second non-joint body appendage.

The physiological state estimates may include joint physiological states selected from the group consisting of joint kinematics (e.g., angles and velocities), segment kinematics, joint moments, joint powers, joint mechanical work, and a combination thereof.

The physiological state estimates may include muscle physiological states selected from the group consisting of muscle length/velocity, muscle force, muscle applied torque, muscle power, and a combination thereof.

The physiological state estimates may include internal-joint-loading physiological states selected from the group consisting of bone-on-bone contact force, shear forces at joints, and a combination thereof.

The trained deep-learning model may be trained using a plurality of body-conformable sensor data measurements acquired using: (i) body-conformable sensors located at a set of body segments proximal to a set of joints (e.g., elbows, knees, pelvis, back) labeled with joint physiological states (e.g., joint kinematics, segment kinematics, joint moments, joint powers, joint mechanical work), (ii) body-conformable sensors located at a set of body segments proximal to or at a set of muscles (e.g., at arms, legs, thighs) labeled with muscle physiological states (e.g., muscle length/velocity, muscle force, muscle applied torque, muscle power).

The trained deep-learning model may be additionally trained using virtual measurements of external environmental sensor measurements acquired at a set of feet labeled with physical states (e.g., ground reaction forces) for a plurality of cyclic and non-cyclic human activities performed by a set of people.

The body-conformable sensors may be located at a set of body segments proximal to or at a set of joints (e.g., elbows, knees, pelvis, back) labeled with internal-joint-loading physiological states (e.g., bone-on-bone contact force, shear forces at the joints), or a combination thereof.

The plurality of body-conformable sensor data measurements may be acquired for a plurality of cyclic activities and non-cyclic activities for a set of people (e.g., 10 cycle activities and 18 non-cyclic activities).

Method 400 includes outputting (408), via the processor, the physiological state estimates, the physical state estimates, or the combination thereof, wherein the output is used for controls, biofeedback, or monitoring of the user or user activity. The outputted physiological state estimates, the physical state estimates, or the combination thereof is subsequently employed for health or safety-related monitoring of activities or tasks performed by the user. In some embodiments, the outputted physiological state estimates, the physical state estimates, or the combination thereof is subsequently employed for generating biofeedback reports or alerts for activities performed by the user. In some embodiments, the outputted physiological state estimates, the physical state estimates, or the combination thereof is subsequently employed for controlling an exoskeleton or robot.

Each or some of the mechanical sensors may be an inertial measurement unit (IMU) (i) placed at a region of a body appendage or muscle and (ii) configured to generate acceleration data measurements, angular velocity data measurements, orientation data measurements, or a combination thereof acquired at the region of the body appendage or muscle.

Each or some of the mechanical sensors may be an accelerometer (i) placed at a region of a body appendage or muscle and (ii) configured to generate acceleration data measurements, angular velocity data measurements, orientation data measurements, or a combination thereof acquired at the region of the body appendage or muscle.

Mechanical sensor may include a gyroscope (i) placed at a region of a body appendage or muscle and (ii) configured to generate acceleration data measurements, angular velocity data measurements, orientation data measurements, or a combination thereof acquired at the region of the body appendage or muscle.

The bodysuit may be configured to cover a lower-body region of the user, including at least one leg, a thigh, a pelvic region, and a knee (e.g., may additionally include at least a foot). The bodysuit may be configured to cover upper-body parts, including at least one arm, an elbow, and chest (e.g., may additionally include wrist or palm).

The method may be performed in a backpack comprising a battery; and a plurality of cable channels configured to provide wired connections between the mechanical sensors and the controller. In some embodiments, the controller is implemented in a mobile device (e.g., tablet, smartphone) comprising a network interface configured to communicate with the mechanical sensors through a network. In some embodiments, the controller is a remote computing device located in a cloud infrastructure comprising a network interface configured to communicatively operate with the mechanical sensors through a network.

### Example Backpack Controller

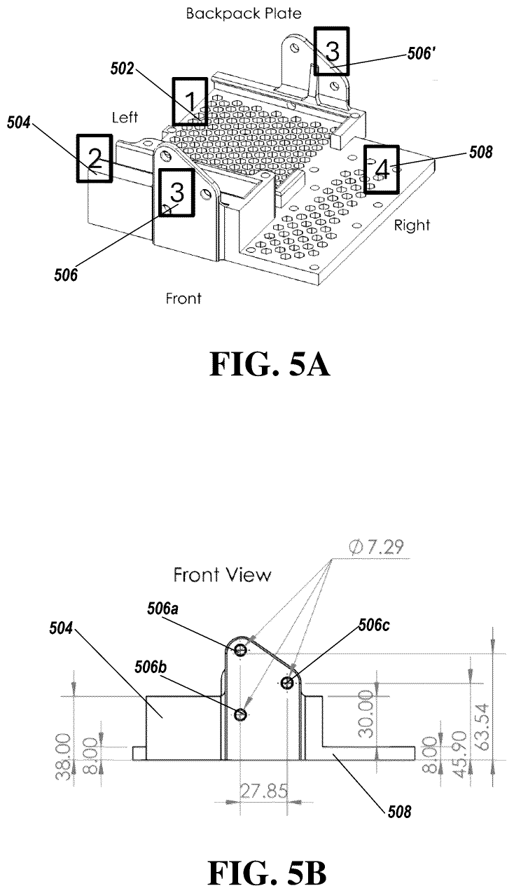

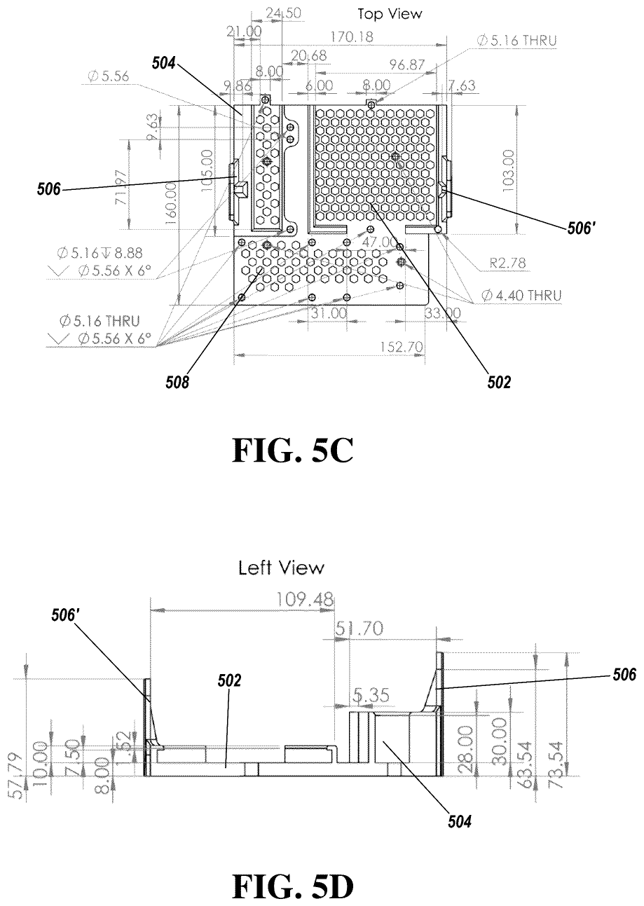

FIGS. 5A-5D show an example backpack plate on which the controller (e.g., 106) of the exemplary system can be mounted when configured as a backpack (shown in FIG. 1D). FIG. 5A shows an overview of the backpack plate. FIG. 5B shows the front view of the backpack plate. FIG. 5C shows the top view of the backpack plate. FIG. 5D shows the left view of the backpack plate.

In FIGS. 5A-5D, the example backpack plate for the controller has a portion 502 (shown as portion 1) configured to house the controller (e.g., Nvidia Orin Jetson nano). The plate 500 may include perforations to dissipate heat from the electrical components of the controller. Portion 504 (shown as portion 2) can house a USB distributor component configured to accept cable connections from mechanical and pressure sensors and facilitate the reception of sensor data measurements by the controller. Portion 506 (shown as 506′, 3) has mounts 506a-506c to connect a power supply to the controller. Portion 508 is a space for mounting other components (e.g., custom circuit boards, buck inverters, etc.) for the controller to interface with other devices.

### Example Electrical Circuit for the Controller

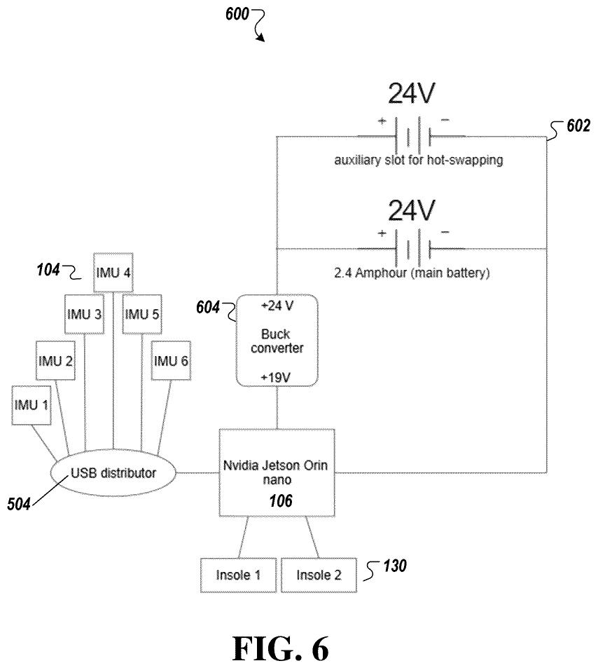

FIG. 6 shows an example system diagram 600 for the controller 106. As shown in FIG. 6, the controller 106 (e.g., Nvidia Jetson Orin Nano) can be cable-connected with a plurality of pressure sensors 130 (i.e., insoles) and with a plurality of mechanical sensors 104 (e.g., IMU #1-#6) via a USB distributor 504. The controller 116 can draw power from a power supply 602, which can be mounted directly on the controller via mounts (e.g., 506a-506c in FIGS. 5A-5D). When the voltage of the power supply 602 exceeds the voltage threshold of the controller 106, a voltage converter 604 can be coupled between the controller 106 and the power supply 602 to convert the power-supply voltage to a voltage acceptable by the controller 106.

Other configurations may be used, e.g., wireless or wire configurations.

In some embodiments, the electrical circuit 600 can be mounted on the backpack plate shown in FIGS. 5A-5D, wherein the controller 106 can be housed by the portion 502, the USB distributor can be housed by the portion 504, and the power supply can be mounted to the portion 506 (shown as 506′) via mounts 506a-506c of the backpack plate.

### Example Fabrication of the Bodysuit (e.g., Second Skin)

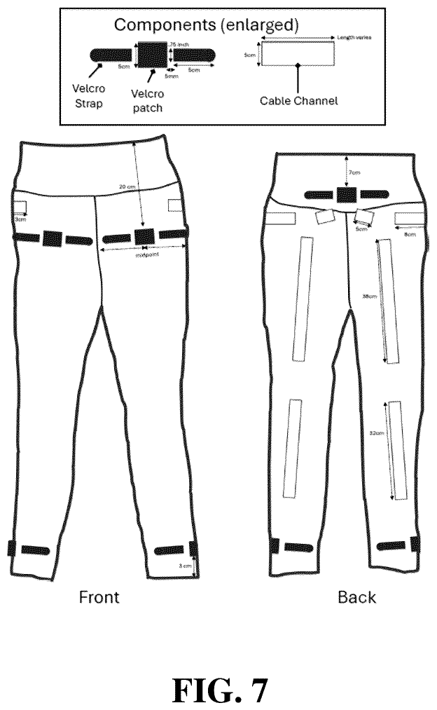

FIG. 7 shows an example bodysuit fabricated as a pair of pants. As shown, the pants can be fabricated in various sizes to fit the user. The dimensions can be relative to the top and bottom, and the distance from the middle seam of the pants. Table 1 shows an example fabrication process for the pair of pants in FIG. 7.

TABLE 1

| Step | Description |
|---|---|
| Preparation of IMUs | Cover the back side of the IMU with hook side Velcro. Use adhesive |
| | if necessary. |
| | Mount handles to the sides of the IMUs (.75 inch slot). |
| Sewing | IMU Mount Locations |
| | Thigh IMU location: Have the user wear the pants and (i) mark |
| | horizontally with chalk on the thighs at groin level, ensuring that the |
| | lines are even and level, (ii) raise each leg to 90-degree bend and mark |
| | where the femur (most raised portion of thigh) meets the line from the |
| | previous step, which is a thigh IMU location, (iii) mark knee location |
| | around the leg, and (iv) mark where the channels may go up the legs |
| | (e.g., channels break at the knees to ensure ease of motion). |
| | Ankle IMU location: (i) flatten pant leg with the seam along the inside |
| | edge, (ii) mark the other edge with chalk, (iii) center the IMU Velcro on |
| | this chalk line, and (iv) bottom edge of the IMU mount is located 1 cm |
| | above the top of the bottom seam or 3 cm above the bottom of the pants. |
| | Pelvis IMU location: 2 cm above the top edge of the center “V” seam, |
| | 7 cm from the top of the pants. |
| | Making IMU Mounts and Straps |
| | Velcro strips for IMU mounts: (i) 40 mm per IMU strip, 2 strips per |
| | mount (10 strips total), and (ii) each Velcro strap can make three strips. |
| | Velcro straps to secure IMUs: (i) cut off plastic loops, (ii) pelvis: 2 |
| | full-length strips, (iii) thighs (x2): 1 full length on the outside (2 total) |
| | and 1 mid length on the inside (2 total) (mid length = 80 mm length or |
| | 40 mm cut off), and (iv) ankles (x2): 2 mid length (4 total) and 1 40 mm |
| | strip (2 total). |
| | Cutting Channels |
| | 50-55 mm wide, length see finished pants, adding shank channels. |
| | Approximate channel length: (i) pelvis (small): 50 mm, (ii) pelvis to |
| | thighs (medium): 110 mm, (iii) thighs to ankles (long): 36 cm, and (iv) |
| | shank (long): 36 cm. |
| | Cut the fabric so that the long sides of the channels are perpendicular |
| | to the grain/lines in the fabric. |
| | Sewing Machine Settings |
| | Length: between 2-3 (NOT S1 or S2). |
| | Stitch: straight (for straps, IMU mount edges, and zippers) or zig zag |
| | (for IMU mount center seams and channels). |
| | Tension: 3. |
| | Needle position: center (change to right for zipper sewing). |
| | Stitch width: 4. |
| | Sewing Order |
| | Pelvis and thigh IMU mounts and straps (skip ankle mounts): (i) |
| | zigzag stitch to connect the two Velcro mount pieces, (ii) straight |
| | stitches on the top and bottom to secure the mount, (iii) pelvis and thigh |
| | straps are sewn 20 mm away from the IMU mounts, and (iv) straight |
| | stitches on the top and bottom of the straps to secure them. |
| | Ankle IMU mounts and straps: (i) Velcro for mounting is sewn |
| | vertically on either side of the zipper, and (ii) ankle straps are sewn 30 |
| | mm away from the IMU mounts. |
| | Channels: Hem the long sides with a zigzag stitch (fold the edge over |
| | and stitch). |
| Placing IMUs | Place Imus onto their designated Velcro patches. |
| | Align them so their long axis is vertical when the user is standing. |
| | Reposition them (thigh IMUs only) so their long axis stays in line with |
| | the femur when the user raises the legs. |
| | Pull Velcro straps through IMU mounted handles and fasten securely. |
| | Thread all IMU cables through their designated cable channels. |

### Example Wearable Exoskeleton System (“Second Skin”)

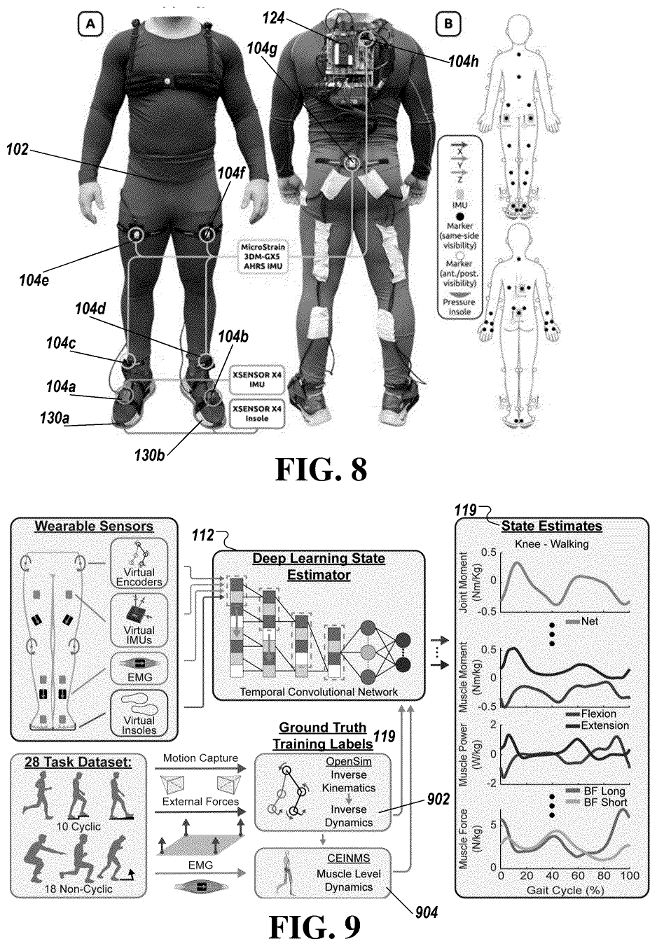

FIG. 8 shows an example wearable exoskeleton system configured for human biomechanics tracking. In FIG. 8 subpanel (a), the exemplary system comprises high-resolution pressure insoles 130a-130b (i.e., pressure sensors) with attached IMUs 104a-104b (i.e., mechanical sensors) at the feet and 6-axis IMUs 104c-104h at the shanks, thighs, pelvis, and back. Each pressure insole 130a-130b (i.e., pressure sensors) can provide vertical ground reaction force (i.e., vertical GRF, vGRF) and center-of-pressure (COP) readings, while the IMUs 104a-104h can provide orientation, linear acceleration, and angular velocity. The pressure insoles 130a-130b can be worn in the shoes, while the shank, thigh, and pelvis IMUs 104a-104h can be strapped to Velcro sewn onto compression pants to achieve skin-level contact with the wearer.

The exemplary system can also include a running backpack 124 having a backpack plate (in FIG. 5A), whose custom housing can include an onboard battery and an integrated computing platform (shown as controller 106 in FIG. 1B). All sensors (e.g., 130, 104) can be fed through sewn-on cable channels or USB distributor (shown as 504 in FIGS. 5A-5D) to provide wired connections to the controller (e.g., Jetson) over a serial connection. The pants 102 and insoles 130a-130b can be available in multiple sizes, and the wearable backpack 124 can be adjusted to accommodate wearers of any size. The computing platform can handle onboard, external communication, and time synching between all sensors.

In FIG. 8 subpanel (b), the motion capture (mocap) marker set and onboard sensors (e.g., IMUs 104a-104h, insoles 130a-130b) can be integrated into the exemplary system in various locations and orientations, which facilitates a complete human biomechanics tracking operation of the exemplary system.

### Example Artificial Intelligence (AI) Model (i.e., Deep Learning Model) Training

FIG. 9 shows an example deep-learning neural network 112 (e.g., temporal convolutional neural network (TCN)) trained to estimate various internal physiological states of a human. In FIG. 9, ground truth training labels 119 can be derived from a combination of OpenSim inverse kinematics and dynamics 902 and an electrography-informed (EMG-informed) neuromusculoskeletal (NMS) model 904, depending on the estimated state. Virtual sensors computed in OpenSim and recorded EMG measurements can be inputted into the neural network 112 (e.g., TCN) (shown as a deep-learning state estimator) to estimate and predict internal physiological states. The trained neural network 112 can generate representative average estimates 119 for the knee joint during walking, starting with net biological knee joint moment, combined flexion and extension muscle moment, and power, and ending with individual muscle forces.

### Experimental Results and Additional Examples

A study was conducted to develop and evaluate a participant-independent, task-agnostic approach for estimating joint angle and moment at the lower back, hip, knee, and ankle, the design and software for which was made open-source. The study demonstrated that with a large and diverse dataset, deep learning can enable fast and accurate estimates of human kinematics and dynamics. The system of the study achieved competitive performance with previous machine learning and analytically based kinematic and dynamics wearable sensing systems within the literature, and did so while generalizing to a diverse array of tasks and joint states. The study was able to reliably estimate joint moments in a subject-independent and task-agnostic manner, even for tasks with reaction forces at the hands (shoveling, wagon push/pull, static push/pull), which were extremely challenging tasks for analytical-based solutions. In the future, this work should be expanded on with larger datasets and more optimized model training to improve accuracy and generalization further to move towards real-world deployment efforts. This approach to wearable sensing has the potential to revolutionize biomechanics as it could allow for a far more accessible means of collecting data that requires less post-processing, while simultaneously allowing for more natural movement patterns than current biomechanics labs. Likewise, this framework could expand the capabilities of biofeedback systems and wearable robots by enabling better real-time sensing and control.

The study developed and employed an open-source wearable sensing suit, as an example of the exemplary system, that utilizes IMUs and pressure insoles along with a deep learning approach to be a practical solution for characterizing lower-body biomechanics in real-world scenarios. Then, the study compared the joint state estimates from this approach to analytical methods of quantifying the same joint states from wearable sensors. The study hypothesized that our deep learning approach would significantly outperform analytical methods, on a user-independent, task-agnostic basis, because it would account for inaccuracy and inconsistency from sensors. The study demonstrated the value that deep learning combined with a large dataset makes in providing both accurate and real-time (every 5 ms) estimates of human kinematics and dynamics.

Fabricated System. The system employed in the study shown in FIG. 8 includes XSENSOR X4 high-resolution pressure insoles with attached IMUs at the feet (XSENSOR Technology Corporation, Calgary, AB, Canada), as well as 6-axis IMUs at the shanks, thighs, pelvis, and back (3DM-GX5-25, HBK MicroStrain, Williston, VT, USA). Each pressure insole provided vertical GRF (vGRF) and center-of-pressure (COP) readings, while the IMUs provided orientation, linear acceleration, and angular velocity. The pressure insoles were worn in the shoes, while the shank, thigh, and pelvis IMUs were strapped to Velcro sewn onto compression pants to achieve skin-level contact with the wearer.

The system of the study also included a running backpack, whose custom housing includes an onboard battery (Kobalt 24 V 2 Ah, Lowe's, Mooresville, NC, USA) and an NVIDIA Jetson Orin Nano (Jetson) computing platform as a controller. All sensors were fed through sewn-on cable channels to provide wired connections to the Jetson over a serial connection. The pants and insoles were available in multiple sizes, and the wearable backpack was adjusted to accommodate wearers of any size. The Jetson handled onboard and external communication and time-synchronization between all sensors. The Jetson was selected for onboard use for its capability to run real-time deep-learning models.

Data Collection. The study collected gait lab and wearable sensor data from 10 participants, all of whom were drawn from an able-bodied population (gender: 8 M, 2 F; age: 25.18±3.12 years; body mass: 80.54±12.56 kg; height: 1.75±0.09 m).

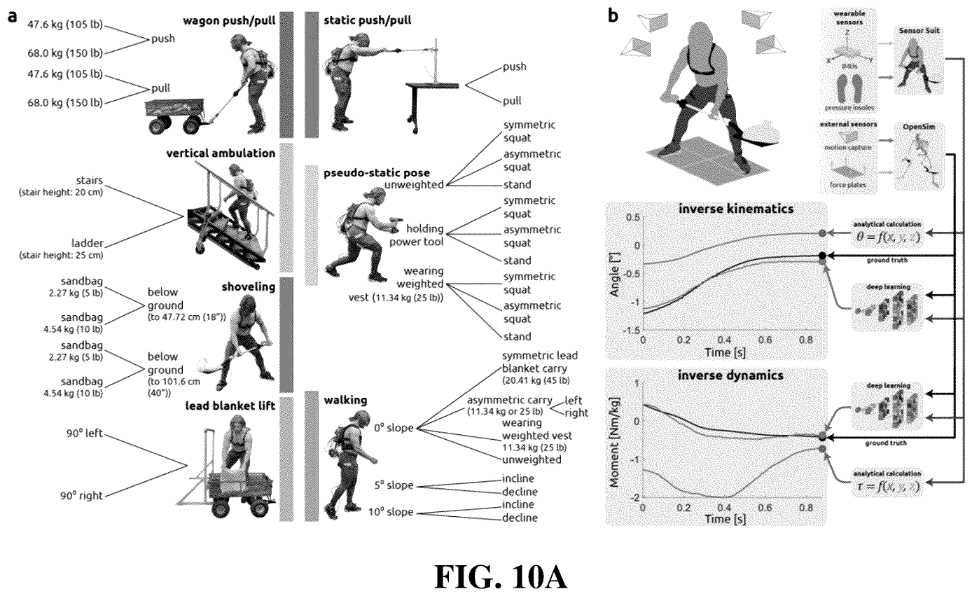

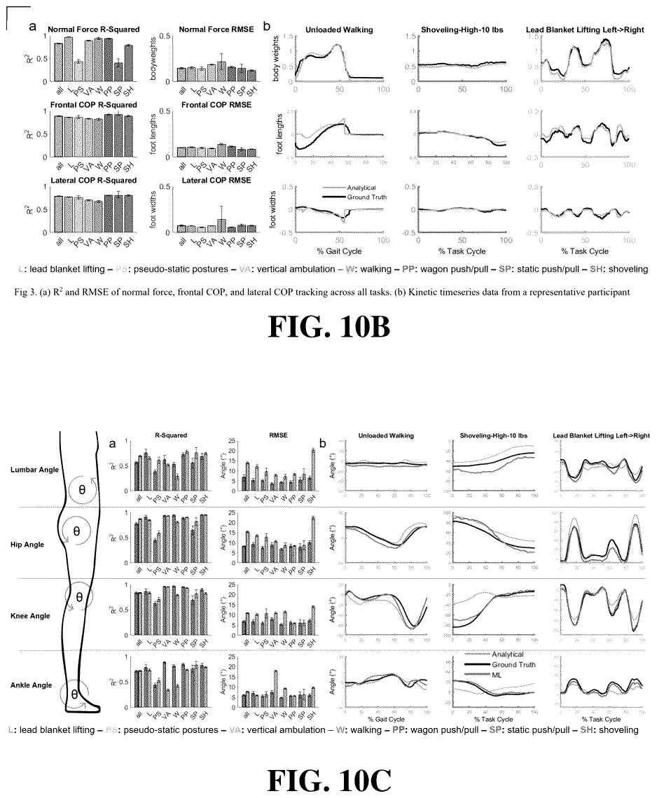

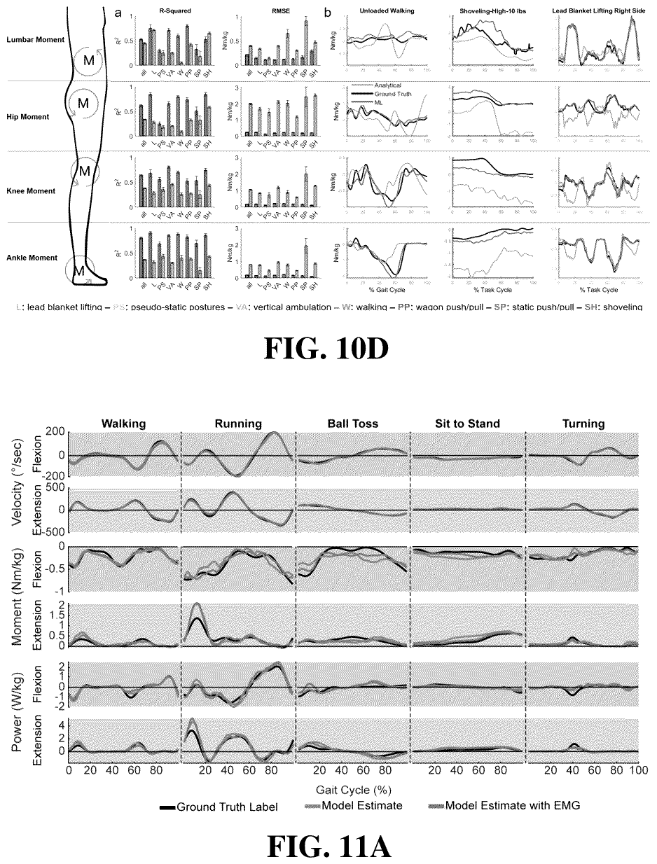

FIG. 10A shows the task set performed by each participant and the data processing operation conducted in the study. FIG. 10A subpanel (a) shows the task set of 6 core activities consisting of 33 conditions: lead blanket lift (L), agon push/pull (PP), pseudo-static postures (PS), shoveling (SH), static push/pull (SP), vertical ambulation (VA), and walking (W). In FIG. 10A, subpanel (a), each individual performed various tasks designed to mimic the workload of manual laborers. Each category had several sub-conditions of tasks performed. Sub-conditions in the task set were performed for either 5 or 10 repetitions, depending on the complexity of the task, with participants completing each repetition at their own pace. The exceptions to this were loaded walking and pseudo-static postures, where each sub-condition was performed only once for 30 seconds.

FIG. 10A subpanel (b) shows the data processing operation. In FIG. 10A subpanel (b), force plate data, including vGRF and COP, were recorded at 2000 Hz on an instrumented split-belt treadmill for walking trials and floor-embedded force plates for the rest of the task set (e.g., Bertec Corporation, Columbus, OH, USA). Load cell data from an ATI mini (e.g., ATI Industrial Automation, NC, USA) were similarly sampled at 2000 Hz for shoveling, static push/pull, and wagon push/pull tasks to enable the calculation of reaction forces at the hands. Motion capture data were recorded at 200 Hz (e.g., Vicon Nexus, Vicon Motion Systems, Yarnton, Oxfordshire, UK) using the marker set shown in FIG. 10A, subpanel (b). MicroStrain IMUs were sampled at 200 Hz, and the X4 sensor pack and X4 high-resolution insoles were sampled at 80 Hz. Wearable sensor data were synchronized with motion capture and force data using a Vicon lock box synchronization pin.

The study computed ground truth joint angles and moments from mocap, force plate, and load cell data using the inverse kinematics and inverse dynamics tools in OpenSim 4.0 (e.g., Gait2392_Simbody model), with a 6 Hz Butterworth lowpass filter applied to mocap and force data. Although this model accounted for multiple degrees of freedom (DOFs) at the ankle, hip, and lower back, the study restricted the analysis of joint kinematics and dynamics to just the sagittal plane component of the ankle, knee, hip, and lower back.

Joint Moment Estimation. The machine learning algorithm implemented in the study to estimate lower-body joint moments was a variant of the TCN developed by Bai et al. and further developed by Molinaro et al. for the purposes of biological moment estimation for hip/knee exoskeleton control. The TCN architecture benefited from dilation between model layers, maximizing the time history used in estimating each successive time point while minimizing redundant network connections. To estimate the biological joint moments of cyclic and non-cyclic manual labor tasks, the study trained TCN models with hyperparameters optimized for a similar able-bodied dataset comprising cyclic and non-cyclic tasks [29]. The TCN was trained and tested in Python 3.6.9 using PyTorch 1.8.0 [30], using 5 temporal convolutional blocks, each containing two convolutional layers with interstitial weight normalization and activation layers. The rectified linear unit (ReLU) was used as the activation function here for its previously demonstrated benefits in time series prediction implementations of deep learning models [31]. Each model was trained using the Adam optimizer and a mean squared error (MSE) loss function, a learning rate of 5e-5, a dropout probability of 0.15, and 80 filters per hidden layer, corresponding to a time history of 248 points. Each new model was trained from random initialization with a ten-fold leave-one-subject-out validation for 150 epochs.

Load Cell Force Resolution. The study used a pole instrumented with a 6-DOF load cell to quantify the reaction forces at the hands for wagon pushing/pulling, static pushing/pulling, and shoveling. Equation Set 1 was solved to resolve the reaction forces at the right and left hands.

$$\sum {F}_{x} = {F}_{x}^{Loadcell} \qquad ( Eq . Set 1 )$$

$$\sum {F}_{y} = {F}_{y}^{Loadcell}$$

$$\sum {F}_{z} = {F}_{z}^{Loadcell}$$

$$\sum {M}_{x} = {M}_{x}^{Loadcell}$$

$$\sum {M}_{y} = {M}_{y}^{Loadcell}$$

$$\sum {M}_{z} = {M}_{z}^{Loadcell}$$

Equations 2A and 2B show calculations of the expanded force and moment equations in the z-direction. The most general form is provided; certain terms can be zero.

$${F}_{z}^{Right} + {F}_{z}^{Left} + {F}_{z}^{Load} = {F}_{z}^{Loadcell} \qquad ( Eq . 2 A )$$

$$( {d}_{x}^{Right} \times {F}_{y}^{Right} ) + ( {d}_{y}^{Ri ght} \times {F}_{x}^{Right} ) + ( {d}_{x}^{Left} \times {F}_{y}^{Left} ) + ( {d}_{y}^{Left} \times {F}_{x}^{Left} ) + ( {d}_{x}^{Load} \times {F}_{y}^{Load} ) + ( {d}_{y}^{Load} \times {F}_{x}^{Load} ) + {M}_{z}^{Right} + {M}_{z}^{Left} + {M}_{z}^{Load} = {M}_{z}^{Loadcell} \qquad ( Eq . 2 B )$$

In Equations 2A and 2B, the superscripts Right, Left, and Load denote contributions from the right hand, left hand, and load, respectively. d denotes the distance from an applied force to the load cell, determined via motion capture data. The study assumed that moment and force were the same at the left and right hands for wagon pushing/pulling and static pushing/pulling due to the symmetric nature of the tasks. For shoveling, the force and moment at the left and right hands were the same through the axis of the pole (z-direction), and neither hand exerted a moment in the x and y directions.

Analytical kinematics and dynamics. In addition to training TCNs for angle and moment estimation, the study calculated joint angles and moments from raw sensor outputs to serve as a comparison metric for the performance of the TCN models. For kinematics, sagittal plane angles were calculated by taking the difference in segment angles of two IMUs across a joint. To calculate joint moments, IMU-derived lower-body joint angles, normal force from the pressure insoles, and COP from the pressure insoles were substituted in for lower-body inverse kinematics from motion capture, the normal force measured by force plates, and COP measured by force plates, respectively. Then, these inputs were run through the inverse dynamics tool in OpenSim. Ground truth upper body joint angles, shear reaction forces and moments, and model scaling properties from a full motion capture set were still used for this calculation to create a ‘best case’ calculation against which to compare TCN results, as the fabricated system did not have a corresponding measurement to these key inputs to inverse dynamics analysis. The study allowed the ground truth to ‘cheat’ in this way to demonstrate the performance of the deep learning system against the absolute best case of the analytical system; in reality, its performance may be worse than in the instant study.

MATLAB 2024a (e.g., The Mathworks, Natick, MA, USA) was used to perform two-sample t-tests between analytically derived joint angles and moments, and TCN estimates of joint angles and moments, using an alpha value of 0.05 for every type of task within the task set.

Results for Ground Reaction Forces. FIG. 10B shows the coefficient of determination (denoted as R²) and root mean squared error (RMSE) values for the ground reaction forces tracking of the system of the study (FIG. 10B, subpanel (a)) and the kinematic time-series data from a representative participant (FIG. 10B, subpanel (b)). In FIG. 10B subpanel (a), normal force, frontal COP, and lateral COP had RMSE values of 0.144±0.021 body weights, 0.102±0.009 foot lengths, and 0.074±0.012 foot widths, respectively, across all participants and tasks. Walking had the highest RMSE values of every task type for normal force (0.217±0.087 body weights), frontal COP (0.146±0.015 foot lengths), and lateral COP (0.148±0.093 foot widths). Pseudo-static postures and static push/pull had low R² values for normal force tracking (0.439±0.040 and 0.411±0.092, respectively) because the ground truth signal for these tasks was constant.

Results for Kinematics. FIG. 10C shows the coefficient of determination (denoted as R²) and root mean squared error (RMSE) values of analytically derived and TCN-derived estimates of kinematics (FIG. 10C, subpanel (a)) and the kinematic time-series data from a representative participant (FIG. 10C, subpanel (b)). In FIG. 10C subpanel (a), the TCN estimates had lower overall RMSE than the analytically derived joint kinematics at every joint except the ankle (p<0.05), with the most extreme case being a relative RMSE reduction of over 50% at the lower back. At the ankle, TCN estimate RMSE was lower than analytically derived RMSE for vertical ambulation, walking, and shoveling (p<0.05). Analytically derived RMSE was not lower than TCN RMSE for the kinematics of any task type at any joint.

Result for Joint Moments. FIG. 10D shows the coefficient of determination (denoted as R²) and root mean squared error (RMSE) values of analytically derived and TCN-derived estimates of normalized joint moments (FIG. 10D, subpanel (a)) and the joint moment time-series data from a representative participant containing ground truth joint moment, analytically derived joint moment, and TCN estimates of the joint moment (FIG. 10D, subpanel (b)). In FIG. 10D subpanel (a), overall RMSE of TCN moment estimates at the lower back, hip, knee, and ankle was 0.218±0.073 Nm/kg, 0.237±0.041 Nm/kg, 0.196±0.038 Nm/kg, and 0.188±0.035 Nm/kg, respectively. The TCN estimates had lower overall RMSE than the analytically derived moments for every task at every joint (p<0.05). The worst performance of TCN estimates by a wide margin was at the lower back for shoveling (0.295±0.093 Nm/kg) where there were reaction forces at the hands that the system was not equipped to sense. This is shown within the timeseries data from the representative participant in FIG. 10D subpanel (b). Overall RMSE of analytically derived joint moments at the lower back, hip, knee, and ankle was 0.399±0.011 Nm/kg, 2.00±0.025 Nm/kg, 1.06±0.029 Nm/kg, and 0.805±0.052 Nm/kg, respectively.

Additional experimental results may be found in Casey et al, “The Second Skin: A Wearable Sensor Suite that Enables Real-Time Human Biomechanics Tracking Through Deep Learning,” to be published.

### EMG in Deep Learning Human Physiological State Estimation

The study additionally developed a deep learning framework and wearable sensor inputs to directly estimate internal joint and muscle level physiological states of the lower limb across a wide range of cyclic and noncyclic activities. The study demonstrated the additional benefit of including EMG in both the training labels and in the inputs to the DL model. While EMG data is not needed to effectively estimate net joint level states, the study observed a significant increase in model performance as the deep neural network can estimate deeper muscle level states, such as combined flexion and extension states, or individual muscle forces. The approach developed in the study provides a potential method to avoid invasive in vivo sensing modalities to predict muscle level dynamics, with the goal of using these predictions for wearable device control or joint health monitoring during community ambulation and strenuous activities. Furthermore, the study shows the effectiveness of surface-level sensors such as EMG for muscle-level state estimation that can be used as advanced sensing technology both for use in real-time device control, and in the mapping of calculated muscle-level states to experimentally recorded muscle dynamics.

Neural Network Model Training. The study used a temporal convolutional neural network (TCN), as described in Molinaro et al. [34′], to estimate different joint and muscle-level physiological states. First developed by Bai et al. for sequence modeling tasks, TCNs used causal convolutions and dilation to increase the time history data that the model used while reducing overall model complexity [40′], [41′]. Recently, TCNs can estimate joint level states, such as biological joint moment, with high accuracy [32′], [33′], [34′]. The network the study used was based on the architecture detailed in Molinaro et al. [34′], with five residual block layers with a channel size of 80 and a kernel size of 5, representing a history of 1.24 seconds with a 200 Hz sampling rate. Each residual block layer consisted of two one-dimensional convolutions with weight normalization and a rectified linear unit (ReLU) activation function. During each convolution, the dilation factor increased exponentially to expand the size of the input time series data used for model training. Additionally, to avoid potential overfitting of the model to the input data, the study used spatial dropout to remove layer inputs across entire feature maps probabilistically. Further details of the base model architecture are available in [32′] and [34′].

Model inputs included common hip and knee exoskeleton sensors, as described in [42′], [43′], [44′]. The sensors included hip and knee angle and velocity, a thigh IMU, a shank IMU, and center of pressure (COP) and ground reaction forces measured through simulated pressure sensing insoles. For models trained with EMG data as an input, experimentally recorded channels from eight muscles that span the hip and knee were used: gluteus medius, gluteus maximus, gracilis, biceps femoris, vastus lateralis, rectus femoris, tibialis anterior, and medial gastrocnemius. The study incorporated inputs into the model in a side-independent manner by mirroring left-leg data to match the coordinate system of the right leg. Similarly, to achieve subject-independent model training, relevant inputs, such as forces and EMG channels, were normalized by the subject's body mass. The study also explored the effects of different sensor inputs on model performance by sequentially adding different sensor modalities to the model. The study trained the subject-independent model using an early stopping criterion based on a validation subject (patience=20). The study then evaluated the model on a separate held-out test subject. The study initialized the model weights to random values, with mean squared error as the loss function.

To train the internal physiological state estimator, the study implemented a leave-one-subject-out cross-fold validation using a 12-subject dataset. For each model, the study held out one subject as a test subject and a second subject as a validation subject for early stopping. The study used the remaining 10 subjects as the training set for the model, where the model predicted different internal states of the test subjects. The study tested different sensor inputs to determine the benefit of including different wearable sensors as inputs to the model and the overall impact of EMG sensing when estimating internal muscle level dynamics. The study then evaluated the performance of each model using the coefficient of determination, R², which the study calculated based on a best-fit line between the ground truth labels and model estimates, both across individual tasks per subject and across all tasks averaged per subject. For all state estimators, regardless of the training dataset, the study established the EMG-informed, CEINMS-driven outputs as the true ground truth muscle level dynamic measurements and used this dataset as a testing set for each model. The study then compared each model's estimation results across different training datasets, state estimates, and sensor inputs.

Able-Bodied Dataset. Using a dataset previously collected, the study instructed 12 subjects (7 males, 5 females, mean±SD age=21.8±3.2 years, height=176.7±8.6 cm, weight=76.9±14.4 kg) to perform 28 different cyclic and noncyclic tasks focused on different categories of human motion: community ambulation, postures and slow movements, athletic maneuvers, and perturbation responses [35′]. The study outfitted subjects with kinematic sensors (motion capture and IMUs), kinetic sensors (force plates), and EMG and instructed them to perform different activities within the experimental space containing an instrumented treadmill (e.g., Bertec, Columbus, OH, USA), in-ground force plates (e.g., Bertec, Columbus, OH, USA), and a custom adjustable height terrain park capable of achieving different American with Disabilities Act (ADA) compliant stair and ramp heights. The study placed EMG sensors bilaterally on the gluteus medius, gluteus maximus, gracilis, biceps femoris, vastus lateralis, rectus femoris, tibialis anterior, and medial gastrocnemius muscles. In the absence of maximum voluntary contractions (MVC) and based on previous studies [45′], [46′], [47′], the study averaged maximum activation values per muscle from three maximum vertical jumps for each subject to normalize EMG data across all trials. The complete breakdown of tasks and more details about the collected data can be found in [35′].

Ground Truth Muscle Level Dynamics. Several analytically based approaches to estimating muscle level dynamics include individual muscle forces, muscle moments, or muscle shortening velocities. To calculate the ground truth labels used to train the DL model of the system of the study, the study used two methods to calculate muscle level dynamics: static optimization (representing the most standard method without EMG) available through OpenSim [10′] and an EMG-informed NMS model, CEIMNS, developed by Pizzolato et al. [11′]. Static optimization consisted of an analytical linear optimization method used to predict muscle forces based on minimized muscle activations, given maximum isometric force and muscle force-length-velocity properties [8′], [9′], [20′]. Inputs to the static optimization tool in OpenSim consisted of external load data (i.e., ground reaction forces), inverse kinematics data, and a subject-specific scaled Gait 2354 OpenSim model containing inertial parameters of the subject [38′]. Outputs from the static optimization tool included calculated muscle activations, minimized muscle activations, and muscle forces.

Static optimization, however, did not appear to account for muscle activity or individual muscle activations that can be recorded via EMG. CEINMS was an OpenSim plug-in that enabled the use of EMG-driven and EMG-informed algorithms to be used with any number of degrees of freedom and musculotendon units [11′]. CEINMS derived the muscle excitation patterns within recorded EMG data and used these patterns coupled with a Hill-type muscle model [48′], to solve for muscle level dynamics. Inputs to the CEINMS Toolbox consisted of musculotendon lengths and muscle moment arms derived from OpenSim's Muscle Analysis tool, subject-normalized EMG activations, and inverse dynamics calculated through OpenSim. Outputs from CEINMS consisted of EMG-informed muscle forces, muscle fibers, and tendon dynamics.

The study ran static optimization (no EMG) and CEINMS (EMG-informed) for all trials within the 28-task, 12-subject dataset. The study calculated individual muscle moments using muscle moment arms derived from the OpenSim Muscle Analysis tool and the muscle forces derived from static optimization and CEINMS as in Equation 3A. Similarly, the study derived muscle power using the muscle shortening velocity and muscle force outputs from static optimization and CEINMS per Equation 3B.

τ_{muscle}=r_{muscle}·F_{muscle} (Eq. 3A)

P_{muscle}=F_{muscle}·V_{muscle} (Eq. 3B)

To sum up muscle moments, powers, and velocities into combined flexion and extension state variables, the study combined muscles based on muscle directions and groupings outlined in the Gait 2354 OpenSim model [38′], i.e., knee flexion consisted of the combination of the biceps femoris long and short heads, gracilis, medial gastrocnemius, and sartorius and knee extension moments were the combination of the rectus femoris and the Vasti group, where the Vastus Lateralis EMG accounts for the entire quadriceps group. The study converted physiological state data into side-independent state variables by mirroring left-leg data to match the coordinate frame of the right leg. For each physiological state, the study combined respective data with the previously described inverse kinematics, inverse dynamics, and EMG data to create a ground truth dataset used as the labels for DL model training and testing.

Representative Subject and Task Selection. To choose a representative subject and task time series data, the study chose a random subject from the dataset: subject AB01. The study chose representative tasks—in this case, walking, running, medicine ball toss, sit-to-stands, and turning transitions—to represent different types of tasks within the dataset, i.e., cyclic and noncyclic tasks. Walking and running represented commonly studied cyclic tasks, while medicine ball toss, sit-to-stands, and turning transitions represented noncyclic and unstructured tasks that may be experienced during daily ambulation or exercise.

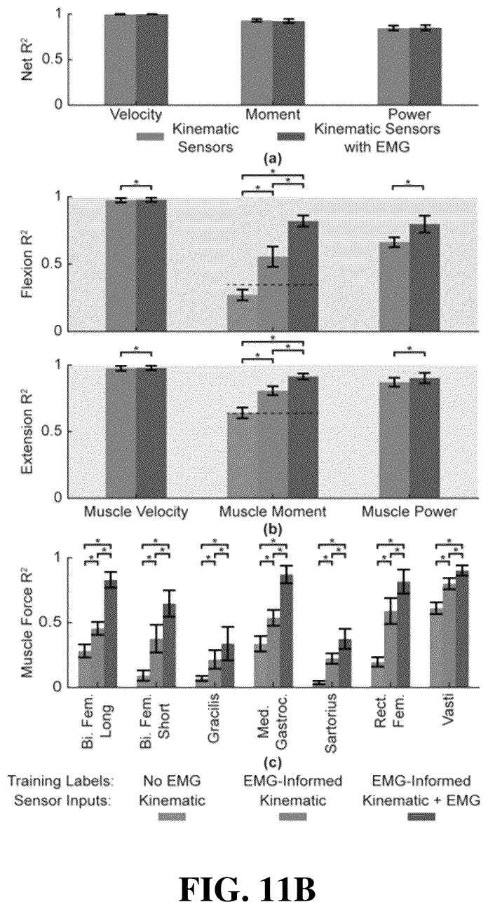

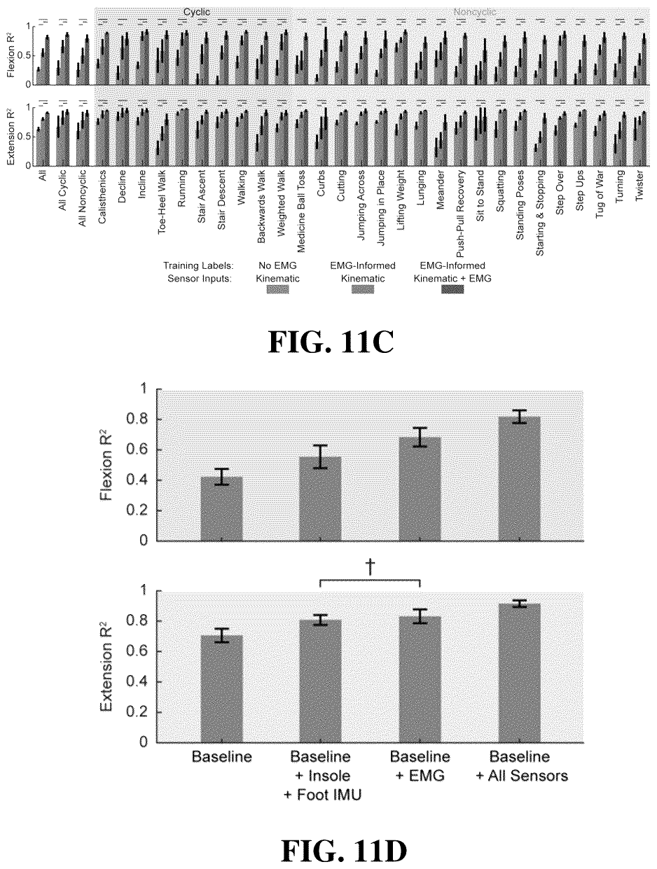

FIG. 11A shows a time-series tracking of an individual stride for combined knee flexion and extension muscle moment, power, and velocity for five tasks (e.g., walk, run, ball toss, sit-to-stand, and turn). For this analysis, the study analyzed the knee joint, with R² values corresponding to the overall averaged combined knee flexion and combined knee extension moments per task. The study developed a custom optimization algorithm to select five tasks that matched the overall average R² of combined muscle parameters, specifically knee flexion and extension moments, by evaluating all possible task combinations and selecting the set with the smallest R² difference (excluding standing poses). The study time-synced and segmented ground truth labels and DL estimates into gait cycles based on heel strikes, where the study plotted individual time series gait cycles by selecting the cycle with an R² closest to the task average. The study plotted the same gait cycle for all internal state estimates, as shown in FIG. 11A.

The study computed statistics across different sensor inputs, different training and testing datasets, and across different subjects and tasks in MATLAB (e.g., The Math Works Inc., Natick MA) using a one-way, repeated measures Analysis of Variance (ANOVA) test with a post-hoc Bonferroni correction, a significance level of α=0.05, the subjects as random factors and the different sensor conditions as the dependent variables. The study averaged R² values for each task across all subjects, which the study then averaged to provide the overall accuracy for each model training condition. Furthermore, the study used a multiple comparisons approach with a posthoc Bonferroni correction to examine individual differences within model training and sensor inputs for each state estimate, within-task differences across all tasks in the dataset, and across the addition of different sensors as inputs to the deep learning model.

Result for Physiological State and Muscle Force Estimation. FIG. 11B shows the temporal convolutional neural network estimation results for 3 different levels of physiological state, including (i) net knew joint velocity, moment, and power, (ii) muscle-level combined knee flexion and extension velocity, moment, and power with and without EMG, and (iii) individual knee muscle forces. In FIG. 11B, subpanel (a), when estimating net biological joint states, such as net velocity, moment, and power, the addition of EMG did not benefit TCN accuracy. This trend was shown for the knee joint, but a similar trend was also presented at the hip and ankle joints.

When estimating knee joint combined muscle level flexion and extension states, as well as individual muscle forces, utilizing EMG data to derive training labels (via CEINMS) and as inputs to the model both added benefits to the TCN (p<0.05). The TCN accurately estimated muscle flexion and extension velocities at the knee with an improvement in model performance (p<0.05) of 0.35% with the inclusion of EMG as an input to the model. For combined knee flexion and extension muscle power, the study observed a similar trend, with the inclusion of EMG in both model training and testing improving model accuracy (p<0.05) by 10.8% compared to only including EMG in model training. For combined knee flexion and extension muscle moments, the study added a third condition consisting of labels derived without EMG (static optimization) and only Kinematic sensors (No EMG). Likewise, to further highlight the differences between static optimization and CEINMS, a reference line was shown for the combined muscle moment comparisons, representing the theoretical best performance that the No EMG labels can do i.e., direct correlation between the two ground truth derivation methods, with an R² of 0.344±0.040 and 0.635±0.060 for flexion and extension, respectively. The one-way repeated measures ANOVA detected a (p<0.05) improvement in the model performance of 33.7% and 47.9% for the EMG-informed, Kinematic sensors and EMG-informed, Kinematic+EMG conditions when compared to the No EMG, Kinematic sensors condition, respectively. Likewise, the EMG-informed, Kinematic+EMG condition improved model accuracy by 21.4% (p<0.05) when compared to the EMG-informed, Kinematic sensors condition. To further show the accuracy of the TCN when estimating combined muscle moments with and without EMG, the study showed the representative single stride tracking results in FIG. 11A.

When estimating individual forces within the muscles spanning the knee, the addition of EMG into the training labels and as an input to the model both added a (p<0.05) benefit to the TCN accuracy (FIG. 11B, subpanel (c)). Including EMG data in both the training labels and model inputs significantly improved (p<0.05) model accuracy by an average of 33.1% and 66.0% when compared to not including EMG as a model input and to static optimization labels, respectively. Likewise, the inclusion of EMG in the training labels of the model significantly improved (p<0.05) model performance by 49.2% compared to static optimization labels. Similar trends can also be observed at the hip.

Results of Individual Task Estimation. To further elucidate the effects of adding EMG to the DL system, the study expanded the comparison between the No EMG, EMG-informed, and EMG-informed with the addition of EMG as a model input approach across all tasks within the dataset using a one-way repeated measures ANOVA within each task. FIG. 11C shows the task-by-task comparisons for combined knee flexion and extension muscle moment estimation based on labels derived from static optimization (No EMG), CEINMS (EMG-informed), and EMG-informed with EMG as a model input (EMG-informed, Kinematic+EMG) for all 28 tasks within the above-discussed dataset. Tasks were divided into Cyclic (10) and Noncyclic (18) tasks, with averages for All Tasks, Cyclic, and Noncyclic tasks shown. Error bars depict+1 standard deviation, and horizontal lines depict statistical significance (p<0.05).

In FIG. 11C, the EMG-informed plus EMG as a model input approach was better (p<0.05) than the No EMG approach across all tasks and improved model accuracy on average by 45.7% and 49.3% for cyclic and noncyclic tasks, respectively. This approach also improved (p<0.05) model accuracy on average by 16.8% and 24.2% for cyclic and noncyclic tasks, respectively, compared to the EMG-informed approach. Furthermore, the EMG-informed approach outperformed (p<0.05) the No EMG approach, with model accuracy improving on average by 34.7% and 33.1% for cyclic and noncyclic tasks, respectively. The study observed similar trends across the hip and ankle joints.

Sensor Analysis. To determine the benefit of different sensor inputs the TCN used to estimate muscle-level physiological states, the study ran a sensor ablation analysis of different sensor combinations commonly found on wearable robotics and exoskeletons. FIG. 11D shows the sensor ablation analysis of different sensor inputs when estimating muscle level flexion and extension moments for the knee joint. All comparisons were significant (p<0.05), with the only exception denoted by + (p>0.05). Error bars depict ±1 standard deviation.

Based on previous joint moment estimation studies that often used IMU and joint encoder data [32′], [33′], [49′], [50′], [51′], [52′], the study tested different combinations of sensor inputs, starting with a baseline sensor suite composed of a thigh and shank IMU and hip and knee joint encoders. Other sensor suite combinations tested included the addition of a pressure sensing insole able to measure GRFs and COP, which included a foot IMU, the addition of EMG, and the combination of all available sensing modalities. Overall, in FIG. 11D, all comparisons between the addition of different sensing modalities provided benefits to the DL estimator (p<0.05), except the addition of EMG when compared to the Baseline+Insole+Foot IMU condition for estimating combined muscle extension. When compared to the Baseline sensor suite, model accuracy for muscle moment estimation was improved on average by 16.9%, 25.3%, and 34.7% with the addition of insoles and a foot IMU (Baseline+Insole+Foot IMU), EMG (Baseline+EMG), or all available sensing modalities (Baseline+All Sensors), respectively. Across all comparisons, including all available sensing modalities, outperformed (p<0.05) all other combinations of sensor inputs, indicating the benefit of real-time GRF and COP measurements and EMG values when estimating muscle level dynamics.

Result discussion. The instant study used a deep learning (DL) model and wearable sensor inputs to estimate the physiological states of the lower limb's internal joint and muscle level across various cyclic and noncyclic activities. Similarly, the instant study demonstrated the additional benefit of including EMG in the training labels and the inputs to the DL model. While EMG data was not needed to estimate net joint level states effectively, there was an increase in model performance as the temporal convolutional network (TCN) estimated deeper muscle level states, such as combined flexion and extension states or individual muscle forces. The exemplary system and method provided a potential method to avoid invasive in vivo sensing modalities to predict muscle level dynamics and to use these predictions for wearable device control or joint health monitoring during community ambulation and strenuous activities. Furthermore, the instant study showed the effectiveness of surface-level sensors such as EMG for muscle-level state estimation, which may facilitate the development of advanced sensing technology both for use in real-time device control and in mapping calculated muscle level states to experimentally recorded muscle dynamics.

Prediction of the internal states and mechanisms within the lower limb joints of the human body can provide insight into human movement, injury recovery, and the effects of degenerative diseases on mobility. These internal physiological states, such as muscle moments or muscle forces, can be used as a means of wearable device control to reduce user energetics while performing an activity [1′], [2′] or can be used to evaluate and predict neurological and orthopedic injuries or conditions [3′].

Measurements of joint and muscle level dynamics are restricted to experimental and laboratory settings, requiring a combination of costly and cumbersome equipment to collect. This equipment includes optical motion capture, in-ground force plates, electromyography (EMG), ultrasound, dynamometers, and/or invasive in vivo sensors [4′]. Furthermore, estimating internal physiological states can be computationally expensive. Previous studies focused on the modeling estimation of muscle forces have converged on three methods: stochastic modeling [5′], [6′], [7′], static optimization [8′], [9′], [10′], and EMG informed neuromusculoskeletal (NMS) models [11′], [12′], [13′]. EMG-informed NMS models, such as the Calibrated EMG Informed Neuromusculoskeletal Modelling Toolbox (CEINMS) developed by Pizzolato et al. [11′], can represent modeling techniques to estimate muscle level dynamics that include recorded EMG data when deriving muscle excitation patterns, co-contractions, and forces [13′], [14′], [15′]. While EMG-informed methods represent a promising approach, there are still limitations due to inaccurate ground truth muscle dynamic values and high startup and computational costs [16′], [17′]. Other methods based on stochastic modeling or static optimization approaches use mathematical or analytical models to estimate ranges of muscle forces. These methods may be faster computationally but have inconsistencies in their muscle level estimation, failing to remain within ground truth measured muscle force ranges, and have been applied to limited cyclic tasks such as normal gait or walking [18′], [19′], [20′].

Estimating internal physiological states via external wearable sensors can represent an alternative to these modeling approaches by removing the need for advanced equipment or computationally expensive models. For example, EMG-based state space models have been used to estimate and predict muscle forces across multiple joints and movements in both the upper and lower limbs [21′], [22′], [23′]. Similarly, data-driven deep learning (DL) approaches can further reduce the complexity of biomechanical modeling and muscle-level state estimation. There are several regression-based algorithms used to estimate the joint, segment, and muscle level kinematics and kinetics using wearable sensors [24′], such as Kalman filtering [25′] or neural networks [26′], [27′], [28′] [29′], [30′] [31′], [30′], [31′], [32′], [33′], [34′]. DL models and neural networks, such as the TCN developed by Molinaro et al. [32′], [33′], [34′], can function with a reduced number of wearable sensors, such as inertial measurement units (IMUs), joint or motor encoders, and pressure sensing insoles, making them a potential solution for data-driven internal physiological state estimation. While promising, these approaches have yet to be applied to deeper physiological states or across various tasks and activities.

To address the limitations associated with computing kinetics and kinematics, as well as with model-based approaches, among other motivations, the instant study adapted the TCN developed by Molinaro et al. [32′], [33′] to estimate both joint and muscle-level internal physiological states. The instant study estimated states at the knee joint for three increasingly detailed levels: 1) net joint level moment, velocity, and power; 2) combined muscle level flexion and extension moment, velocity, and power; and 3) individual muscle forces. For each of the state estimators, the instant study chose the EMG-informed, CEINMS-driven outputs as the true ground truth muscle level dynamics, which the instant study used to test the accuracy of each model. The instant study then evaluated the TCN's ability to estimate each state across various cyclic and non-cyclic tasks accurately. These tasks ranged from cyclic motions such as level ground walking, stair ascent/descent, and running to unstructured and highly agile non-cyclic tasks such as sit-to-stands, squats, and high-speed lateral cutting and were available in open-source datasets [35′]. Using a reduced sensor suite composed of standard sensors found on wearable devices, including simulated shank and thigh IMUs, hip and knee motor encoders, and simulated pressure sensing insoles [36′], the instant study trained a deep learning estimator and evaluated it against ground truth labels derived from both the standard musculoskeletal model that does not use EMG (static optimization) [8′], [9′] and from an EMG-informed NMS model (CEINMS) [11′].

The instant study hypothesized that, given the same set of mechanical kinematic sensors, a deep learning model trained on ground truth internal physiological state labels derived from an EMG-informed NMS model may outperform a similar system using ground truth labels derived from static optimization (one of the most standard methods available that does not use EMG). Purely kinematic sensors may provide enough information to estimate muscle level dynamics more accurately than state-of-the-art static optimization-based approaches, provided the ground truth labels used for model training are informed by experimentally recorded EMG muscle activations. Similarly, the direct addition of normalized, side- and subject-independent EMG sensor values as inputs to the DL model may provide an improvement in model performance (R²) when compared to models trained without the inclusion of EMG into the model. By including EMG as a model input, the DL system had access to pseudo-real-time EMG muscle activations, providing additional information for estimating internal muscle level physiological states. Previous studies have used different methods to estimate muscle forces on a limited number of tasks, such as self-selected walking speed, level ground walking, running, sidestepping, and crossover cutting [7′], [16′], [37′]. The instant study developed used a deep learning estimator to estimate muscle level dynamics and physiological states for a set of tasks beyond normal gait, ranging from cyclic tasks such as walking, running, and backward walking to dynamic, noncyclic tasks such as tossing a medicine ball, sit-to-stands, turning transitions, and perturbation recovery.

The instant study developed a system to estimate muscle level dynamics using wearable sensors and a deep learning TCN framework and evaluated the exemplary system and method on various physiological states and sensing modalities. Overall, the system of the study using EMG-informed labels outperformed systems trained on ground truth labels derived without EMG, indicating the importance of EMG sensor information when estimating muscle level dynamics (both at the individual and combined muscle levels). This was not true for joint mechanical states such as joint moment and joint power, where EMG activations as model inputs provided no benefit.

When the model was trained on EMG-informed labels, the model may outperform a model trained on labels derived with no EMG. The study showed a benefit from using EMG-informed labels during model training, which was expected because static optimization labels that did not incorporate EMG data did not track well to EMG-informed labels. For example, when looking at the reference line in FIG. 11B, subpanel (b), the best performance tracking between the EMG-informed and no EMG-derived labels only had an R² of 0.344 and 0.635 for combined muscle level knee flexion and extension moments, respectively. Moreover, static optimization may underestimate muscle level dynamics due to the minimization of muscle activations during computation [4′], [7′], [53′], which may limit the amount of information provided to the DL model and was not physiologically accurate. The results from the model trained on EMG-informed labels showed that more information about muscle states can be extracted from kinematic sensors than from static optimization, provided the EMG-informed training labels were accurate representations of muscle level dynamics. Overall, the model trained on EMG-informed labels outperformed a model trained on labels derived with no EMG for muscle level states since EMG-informed labels improved (p<0.05) model performance for all muscle level state estimates.

The addition of EMG data as inputs to the model may improve model performance when compared to a model trained only on EMG-informed labels, indicating that the model may not only need EMG-informed labels to estimate muscle level state estimates (e.g. training data collected with EMG) but also need EMG data during real-time inference to achieve similar accuracy using a real-time EMG system. While the addition of more information to a deep learning model should increase performance, the inclusion of EMG sensor data improved estimation accuracy at the magnitude observed. User-independent EMG data may not provide benefits for device control in the lower limbs [54′], though it is used in myoelectric control of upper limb prosthetic devices [55′], [56′], [57′], with mixed to low efficacy. While the study did not see any benefits using the user-independent EMG-informed approach during joint level state estimates, consistent with studies that either did not use EMG or saw no significant benefit when including EMG inputs to their model [32′], [58′], other researches showed that user-dependent EMG can provide benefits for joint level state estimation [41′]. Real-time EMG, however, can be difficult to incorporate into the control loop of a device due to the high volume of data, delays associated with processing or filtering, and the reliability of electrode placement across users and between uses of the device. Moreover, the subjects used in the model represented similar, able-bodied, healthy individuals with sensors placed on easy-to-target, high-output muscles of the lower limb. These signals were processed via filtering and normalization before being input to the model, which may contribute to the overall success of the model when estimating muscle level dynamic states. Thus, the study posited that actual implementations of the DL pipeline that used EMG in real time may underperform compared to our offline results. Newer DL architectures, however, can extract more information from these signals while handling the high variability of EMG data to improve real-time model deployment and inference further.

The addition of EMG-informed labels and EMG data as a model input benefited model accuracy when estimating individual muscle forces spanning the knee joint (FIG. 11B, subpanel (c)). Muscle forces were difficult to measure in real-time and to compare across studies due to differences in estimation methods, data collection and accuracy, and the precision and reliability of experimentally recorded EMG measurements [3′], [37′], [59′], [60′]. When estimating net biological joint moment, results in the study were consistent with previous studies such as Scherpereel et al., which used a similar set of kinematic sensors, insoles, and subject-dependent EMG to achieve an R² of 0.86 at the knee when estimating joint moments [41′]. Scherpereel et al. [41′] used subject-dependent EMG during estimation, which may inhibit the model from generalizing to different participants, and did not test their estimation paradigm on deeper muscle level states. When estimating individual muscle forces, the instant study outperformed previous studies that used different methods of muscle force estimation found in the literature while also expanding to a wide array of dynamic tasks beyond normal gait. Martelli et al. reported an R² of 0.38 between a stochastic modeling, static optimization-driven approach, and an EMG-informed approach for simulated walking trials; however, Martelli et al. reported issues with the inclusion of multiple EMG channel inputs and when generalizing across users due to the nature of subject-specific EMG [7′]. Similarly, Lin et al. reported muscle force estimation accuracies ranging from 0.213 to 0.980 R² between a static optimization and an EMG-informed approach during walking and running, but Lin et al. was similarly limited to a small number of cyclic tasks and did not apply to more ballistic movements such as jumping [37′]. Sartori et al. used a multi-degree-of-freedom, EMG-driven forward dynamics estimation approach to estimate muscle forces for standing poses, walking, running, sidestepping, and cutting and were able to achieve R² values ranging from 0.17 to 0.98 across lower limb muscles. While Sartori et al. represented more tasks that may be encountered during daily ambulation, it was conducted on a single subject, which can inhibit generalizing across different participants. Overall, the results in the instant study using subject-independent EMG and a deep learning model provided a method to estimate muscle forces across a wide array of cyclic and noncyclic tasks without computationally expensive simulation while also providing a potential avenue for real-time implementation on wearable robotic or assistive devices.

In the task-specific breakdown in the study, there was a large difference in accuracy between combined muscle moment knee flexion and extension. One possible reason for this was that much smaller magnitude torques were produced during flexion than extension, therefore with lower biological torques, smaller errors may propagate throughout the model when estimating joint and muscle level state estimates. The study also observed a difference between cyclic and noncyclic tasks, as the model performed 4.81% worse on noncyclic tasks on average. As detailed in [41′], model performance varies depending on the complexity of the task; therefore, the study expected the TCN estimator to have higher accuracy during these time-repetitive cyclic tasks.

In the sensor ablation analysis, the baseline condition was outperformed by each sensor modality addition with the largest increase in model performance of 34.7% from the addition of both a pressure-sensing foot insole and EMG as a model input, similar to user-dependent results reported by Scherpereel et al. [41′] for joint moments. Overall, kinematic sensors alone did not perform as well when estimating muscle level dynamics compared to the addition of kinetic sensors such as insoles or EMG. The addition of EMG as a model input provided a 12.6% increase in performance, but the difficulty of using real-time EMG as an input to an online model limited the practicality of this sensing modality. However, this method was valuable as a potential avenue to non-invasively study muscle-level dynamics during diverse human movement, which may provide ways to monitor joint health or characterize injury recovery.

There are several limitations to this approach. First, the ground truth labels were derived using an EMG-informed NMS model instead of invasively measured true Golgi tendon forces, which were difficult to measure in real time. EMG-informed NMS models did not require complex invasive experiments [13′], [15′], [19′]; however, more work may be needed to verify these methods when compared to more direct muscle dynamic measurements, e.g., using ultrasound to measure velocity and muscle force-velocity relationships to derive force. Second, the exemplary method was only validated and tested offline. Future testing with real hardware and real-time EMG sensing may be needed to verify the study's findings. Third, real-world sensors, such as IMUs, encoders, EMG, and pressure sensing insoles, were susceptible to noise or sensor dropout during use, which may affect model performance when estimating internal physiological states in real time.

### Joint Loading Industrial Lifts Evaluation

The study also evaluated the exemplary system for estimating the joint contact forces (JCFs) in the knee during dynamic and manual labor tasks.

Experiment Protocols. The study relied on 3 datasets for this experiment. The first dataset was collected from nine participants performing symmetric (0°) and asymmetric (90° and) 180° lifting conditions with starting and ending positions alternating between knee, waist, and shoulder height. The second dataset was collected from ten participants performing symmetric (0°) and asymmetric (90°) lifting conditions with starting and ending positions alternating between knee height and waist height with no exoskeleton (denoted as no exo), an active knee exoskeleton (denoted as active knee exo), and a passive back exo (denoted as passive back exo). Combined, these two datasets provided data on lifting across 19 participants; however, the magnitude of data points for machine learning purposes was still insufficient. The study turned to an open-source dataset collected in a lab group [61′], which contained informative cyclic and noncyclic daily tasks, from which the study not only added a considerable amount of data but also broadened the JCF estimation abilities to a diverse set of movements. In addition to 19 participants providing data to the two above-discussed datasets, twelve participants performed calisthenics, various modes of walking, lifting weights, stair ambulation, agility tasks (e.g., cutting), etc.

Participants in the unassisted lifting condition and exo lifting study wore a full-body reflective marker set to record segment positions (e.g., Vicon, Oxford, UK, 100 Hz). Participants in the dynamic tasks condition wore a lower-limb and torso reflective marker to record segment positions (200 Hz).

The study collected ground reaction forces (GRFs) under each foot (e.g., Bertec, Columbus, OH, USA, 2000 Hz). Steady-state walking, running, step-over, and some calisthenics trials were conducted on a split-belt instrumented treadmill, whereas all other tasks were performed on over-ground force plates (e.g., 2000 Hz-unassisted & exo lifting conditions; 1000 Hz dynamic tasks condition).

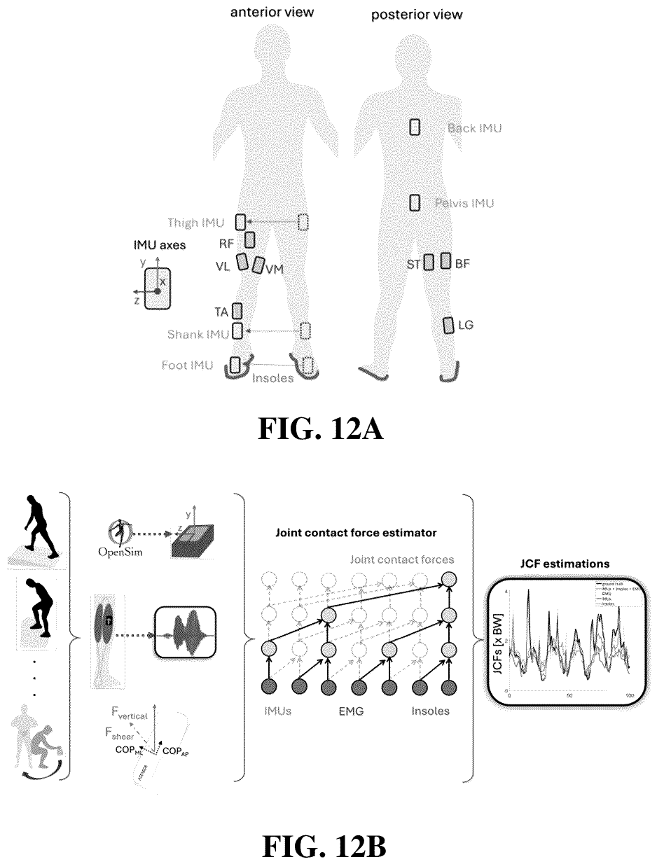

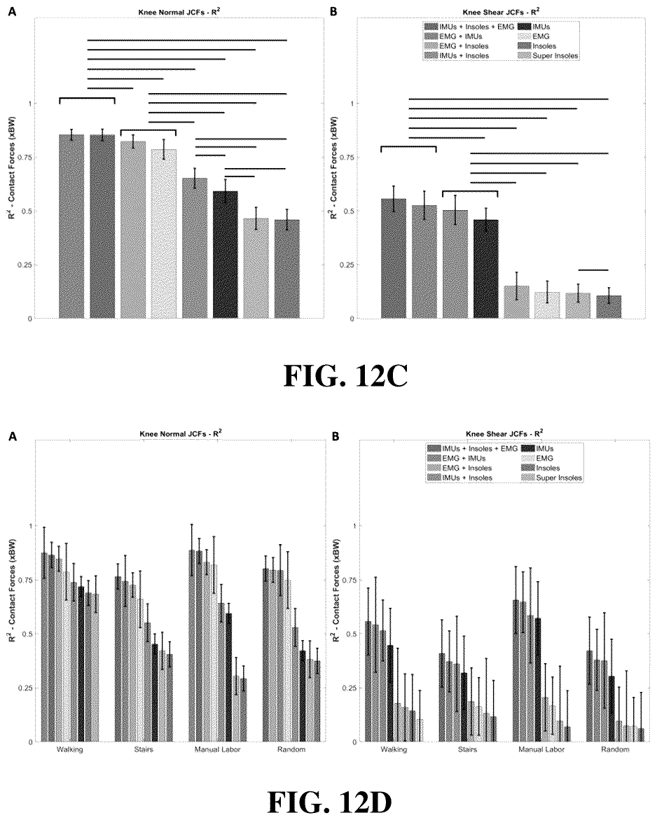

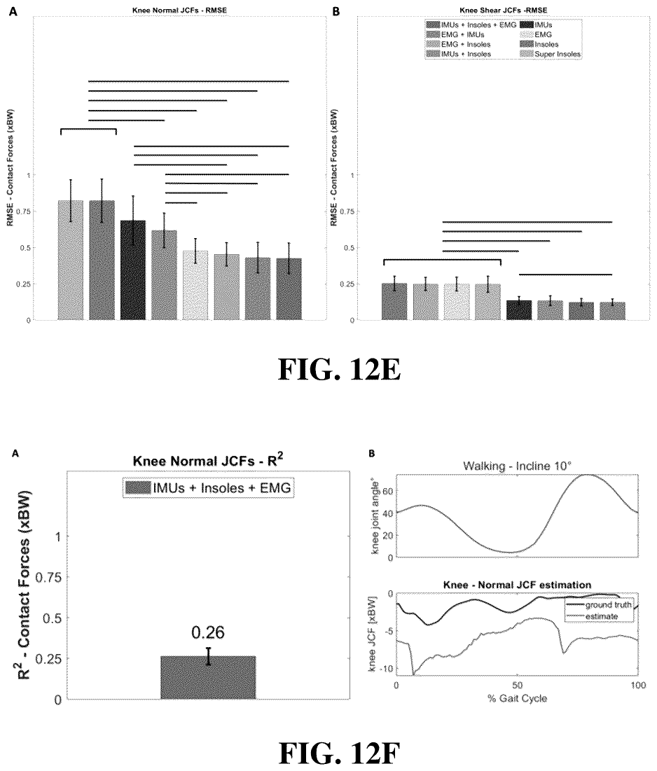

FIG. 12A shows the placements of wearable sensors in the experiment. In the unassisted lifting condition and exo lifting condition, the study collected surface electromyography (EMG) (e.g., Delsys, Natick, Massachusetts, USA, 2000 Hz) from seven muscles in the right leg. These muscles included tibialis anterior (TA), lateral gastrocnemius (LG), rectus femoris (RF), vastus medialis (VM), vastus lateralis (VL), biceps femoris (BF), and semitendinosus (ST). In the dynamic task, surface EMG was collected bilaterally on the left and right legs. These muscles included tibialis anterior (TA), rectus femoris (RF), vastus lateralis (VL), and biceps femoris (BF). SENIAM procedures informed sensor placements [62′].

The study bandpass filtered (e.g., 20-400 Hz, 2nd order Butterworth), full-wave rectified, lowpass filtered (e.g., 6 Hz, 5th-order Butterworth), and half-wave rectified raw EMG signals. The task where most muscles experienced a peak activation was utilized for normalization. The top five maximum activations per muscle within the condition were averaged to provide the normalization factor for each muscle, which was then applied to the respective signals in all trials.

Musculoskeletal Analysis. Motion capture data from the unassisted lifting study, the exo lifting condition, and the dynamic tasks condition were modeled with a modified OpenSim model (e.g., Full Body Running (FBR) model) (SimTK, Stanford, CA, USA) [63′]. The study selected this model because it had a high resolution of knee muscles to better represent the effects of surrounding muscles and tissues on internal joint forces. The study modified ranges-of-motion constraints on the model within the arms, torso, pelvis, and legs to better fit the participants' movements. For the lifting tasks, the study distributed half the dumbbell mass (25 lbs., 12.5 lbs.) to each hand using OpenSim WeldJoint to incorporate the effects of the mass on the skeleton.

FIG. 12B shows an operation of joint contact force estimations that measures joint and muscle level biomechanical data throughout a diverse task set and finds the configuration of wearable sensors that leads to the best estimates of internal joint forces. The operation in FIG. 12B can perform scaling, Inverse Kinematics, Inverse Dynamics, Muscle Analysis, Joint Reaction Analysis, and the Calibrated EMG-Informed Neuromusculoskeletal Modeling Toolbox (CEINMS) [64′]. OpenSim version 4.0 was used for all relevant analyses. The study then divided the resulting knee JCFs into normal and shear components. The study calculated shear JCFs using the Euclidean norm of the anterior-posterior and mediolateral shear forces. JCFs were normalized by the product of participant mass and acceleration of gravity (x BW) and were used as ground truth for training the deep learning model (e.g., TCN).

Simulating Sensors. IMU and insole simulation provided an opportunity to utilize these diverse datasets and test how comprehensive their information can be for a machine learning model attempting to estimate internal joint forces. To do so, the study utilized the joint angle outputs from Inverse Kinematics as inputs to OpenSim's Forward Kinematics tool to compute the simulated kinematics (e.g., linear accelerations, angular velocities, and Euler angles) for each desired segment (e.g., torso, pelvis, thighs, shanks, and feet) as shown in FIG. 12B. GRFs and center of pressures (COPs) were read from force plates and transformed into their respective foot frames to model a pressure insole's reference frame. The Euclidean norm of the mediolateral and anteroposterior shear forces from the force plate was used as a super insole configuration.

The lifting experiments were conducted with only the right left instrumented with EMG; therefore, to maintain consistency in sensor configurations across all three experiments, the study mirrored key IMU and insole signals on the left leg as if they were to be expressed as the right leg in the dynamic task, doubling the knee data of this task set.

Temporal Convolutional Neural Network (TCN) Model. Two separate single-headed TCN models were used for JCF estimations, one for normal knee JCFs and the other for shear knee JCFs with the same structure. The size of the initial layer of the TCN varied depending on the desired sensor input types but consisted of 400 channels and one output variable. Table 2 shows the TCN hyperparameters used in the experiment. The hyperparameters set in this model proved effective for knee joint moment estimations [65′]. The effective time history required from the hyperparameters was 250 data points.

TABLE 2

| | | | | | | Effective | | |
|---|---|---|---|---|---|---|---|---|
| | Kernel | Channel | | Dropout | | history | Learning | Loss |
| Epochs | size | sizes | Levels | probability | Patience | limit | rate | func |
| 250 | 5 | 80 | 5 | 0.15 | 20 | 250 | 5E−5 | MSE |

Data from the unassisted lifting condition, exo lifting study, and dynamic tasks study were utilized in the performance of this JCF estimator. Simulated IMUs were upsampled to double their collection frequency, which led to an increase from 100 Hz to 200 Hz. The study downsampled EMG and simulated insoles to align with the resampled simulated IMU data temporally. The dynamic task dataset comprised 4/7 overlapping EMG from muscles experimentally collected in the lifting studies. Because the experimental EMG was optimized in CEINMS with the simulated EMG (from non-experimentally collected muscles) to resolve muscle forces, the study utilized the adjusted muscle activations for the remaining muscles (ST, LG, VM) for consistency in sensor inputs across studies.

The study developed the input data tables to contain the model's features and labels for the ipsilateral (right) and contralateral (left) leg. The features included 9-axis IMUs (x, y, z for linear acceleration, angular velocity, and Euler angles), insoles (normal force, shear force, mediolateral COP, and anteroposterior COP), and EMG (RF, VM, VL, TA, LG, BF, ST). The labels consisted of normal and shear JCFs from the right and left knees. The model was then configured to read in the relevant ipsilateral features and the desired outcome metric to estimate the other variables were ignored.

The TCN was developed to function independently when training subjects. A leave-one-out cross-validation [66′] approach was applied to the participants by excluding one participant for validation and another for testing. The study constrained the model to use only their data from unassisted and exo lifting conditions in the training set, but not for validation or testing. This means there were always 29 participants in the training dataset (although 19 of those participants did not contribute to most of the task types).

The study trained, validated, and tested two batches of eight different models (16 total)—one batch for normal JCFs and the other for shear JCFs—to evaluate how varying sensor input configurations affect JCF estimation performance and what the minimal set of sensors can provide a reliable estimation metric (R2>0.7) [67′]. The eight versions consisted of the following permutations: IMUs+insoles+EMG, IMUs+insoles, IMUs+EMG, EMG+insoles, IMUs, insoles, super insoles, and EMG. Each model variation can run up to 200 epochs, with early stopping permissible after reaching the preset patience value of 20 (Table 2).

A one-way repeated measures Analysis of Variance (ANOVA) and post hoc Bonferroni pairwise multivariate comparison test informed on the significance of the wearable sensor permutations on JCF estimation (H1) with the threshold for significance set at α=0.05. In the ANOVA, participants were defined as the random effects with the various sensor permutations as the fixed effect. The correlation coefficient (R²) and root mean squared error (RMSE) were computed between the estimated JCFs and ground truth for each trial. Individual-participant averages and group averages for the R² and RMSE of each task type and overall were computed. Custom MATLAB scripts were employed for these statistical analyses (e.g., Mathworks, Natick, MA).

Results of Joint Contact Force Estimates for Generalized Tasks. The study investigated the effects of wearing IMUs, EMG, and insoles on offline normal and shear JCF estimation. Additionally, the study assessed how combinations of these wearable sensors can improve JCF estimations to identify the minimal sensor set required to obtain an R²>0.7137.

FIG. 12C shows the group-averaged coefficient of determination (R²) in normal knee joint contact force (subpanel (a)) and shear knee joint contact force (subpanel (b)). The study leveraged data from dynamic datasets, including walking, lifting, using stairs, jumping, and more, to understand the utility and feasibility of JCF estimations in different contexts. In FIG. 12C, subpanel (a), the TCN model mapped wearable sensor data to the ground truth of normal knee JCFs. Across all tasks utilized in the experiment, wearable sensor configurations that included EMG-only achieved at least an R² value of 0.79 when estimating normal knee JCFs. Adding insoles (R²=0.82), IMUs (R²=0.85), or both (R²=0.88) to an EMG-only sensor set only augmented the model's normal JCF estimation abilities without significance. The following sensor configurations had greater R² values than sensor combinations with IMUs and/or insoles (p<0.01): (1) EMG and IMUs, (2) all, (3) EMG only, and (4) EMG and insoles. Without EMG, the model failed to map IMUs (R²=0.59) to JCFs without insoles (IMUs+insoles, R²=0.65), but it also poorly estimated normal JCFs with solely the use of GRFs (R²=0.45).

FIG. 12D shows the group-averaged root mean square error (RMSE) values in normal knee joint contact force (subpanel (a)) and shear knee joint contact forces (subpanel (b)). To better understand the model's accuracy in estimating JCFs, the study also calculated the RMSE. In FIG. 12D, subpanel (a), in task-agnostic (generalizable) normal knee JCF estimation, the sensor input configuration resulting in the lowest error was all sensors (IMUs, EMG, and insoles) with an RMSE of 0.42, followed by the combination of IMUs and EMG sensors (RMSE=0.43). The following sensor configurations had lower RMSE values than sensor combinations with IMUs or insoles (p<0.01): (1) All, (2) EMG and IMUs, (3) EMG and insoles, and (4) EMG only. Like the R², the RMSE increased without the inclusion of EMG.

On the other hand, the study found the TCN to be unsuccessful in identifying relevant features and relationships between wearable sensor data and shear knee JCFs as the ground truth. Overall, in FIG. 12D, subpanel (b), none of the wearable sensor configurations achieved an R²>0.7137. Using the combination of IMUs, insoles, and EMG again performed the best of the configurations (R²=0.56) in estimating shear knee JCFs. However, IMUs appeared to be responsible for this capability as all the top-performing configurations include this sensor. An IMU-only sensor set can estimate shear knee JCFs (R²=0.46), but the addition of insoles (R²=0.50) or EMG (R²=0.53) showed improvements in the TCN's ability to map to shear JCFs. Sensor configurations utilizing insoles or a super insole may not converge on a strong solution to connect GRFs to shear knee JCFs and shared R²<0.12. The following sensor configurations had higher R² values than sensor combinations without IMUs (p<0.01): (1) All, (2) EMG and IMUs, (3) IMUs and insoles, and (4) IMUs only.

The task-agnostic (generalizable) shear knee JCF estimation performance followed a similar trend with the R². The following sensor configurations had lower RMSE values than sensor combinations without IMUs (p<0.01): (1) EMG and IMUs, (2) all, (3) IMUs and insoles, and (4) IMUs only.

Results of Joint Contact Force Estimates for Industry-Relevant Tasks. To consider deploying this approach as a potential mitigation strategy for joint force and health monitoring, it may be essential to characterize how task classification may influence the TCN's ability to discern task-specific knee JCFs for reliable estimations. The study focused on locomotion modes commonly experienced during a manual labor employee's average daily manual workload: walking, climbing stairs, lifting, and random, aimless movement. The group of walking tasks included normal walking at different speeds, loading a carriage, walking backward, walking on an inclined slope, and walking on a declined slope. The group of stair tasks included stair ascent and descent. Manual labor tasks comprised lifting with and without added weight, lunges, squats, sit-to-stand, tug-of-war, step-ups, and ball tossing. Lastly, the random task group contained movement that occurred throughout the day: meandering, turning, running into something or being bumped (push-pull), stepping over obstacles, standing, awkward stances (twister), and overcoming a curb.

The study found that the TCN excelled at estimating normal knee JCFs across each locomotion mode. FIG. 12E shows the group-averaged R² values in normal knee joint contact force (subpanel (a)) and shear knee joint contact forces (subpanel (b)) in walking, stairs, manual labor, and random task groups. In FIG. 12E, subpanel (a), in all task groups, the sensor configuration of EMG and insoles achieved a performance of R²>0.70 in offline joint loading estimations, with stair tasks being the lowest at R²=0.72. The TCN showed its ability to map an EMG-only sensor set to normal knee JCFs in walking, manual labor, and random movement tasks. The combination of IMUs and insoles was relatable to normal knee JCFs in walking (R²=0.76). IMU-only and insole-only sensor sets mapped poorly to normal knee JCFs, except for IMU-only, achieving an R² of 0.73 in walking.

TCN struggled to find the relationship between the sensor configurations as inputs to the shear knee JCFs as its ground truth across each locomotion mode. Similar to the results of estimating normal knee JCFs, locomotion modes of walking, manual labor, and random tasks achieved higher R+ values in shear knee JCF estimates. In FIG. 12E, subpanel (b), in each task group, sensor configurations using IMUs (IMUs+insoles+EMG, EMG+IMUs, IMUs+insoles, IMUs-only) were the strongest performing sensor sets of the group. The combination of IMUs and insoles performed as well as having an R² of 0.57 in walking, showing the usefulness of GRFs in estimating shear knee JCFs, as the average R² from using an IMU-only sensor set was 0.37. On the other hand, sensor configurations containing insoles were the weaker-performing sensor sets. All combinations of sensor sets obtained an R²<0.20 across all locomotion mode groups.

Additional Discussion. Joint contact forces (JCFs), the three-dimensional forces experienced within the joint capsule, are a useful metric for monitoring joint loading and health. JCFs are affected by surrounding muscles, ligaments, tendons, and external forces [71′] for given joint kinematics. The limited literature on JCFs is due to the inability to extract this metric without using invasive procedures to implant a force transducer within the joint or an instrumented prosthetic device. Furthermore, mechanical analyses that map net external forces and moments to internal joint loads are not straightforward and require estimates of how antagonistic muscle forces are coordinated [72′].

Modern-day musculoskeletal modeling provides the ability to simulate human motion for targeted tasks and conditions [73′], [74′], and also estimates JCFs [75′-78′], [79′]. EMG-informed solvers help capture the essence of muscle coactivation to provide a more accurate representation of forces acting upon the joint or a more realistic calculation of JCFs [80′], [81′]. Muscle forces contribute to the majority of the summed forces in the resulting JCFs, so it is a valuable addition to incorporate this nuance [82′], [83′]. However, the process of taking motion capture data through a musculoskeletal modeling pipeline can be computationally costly and requires accessibility to expensive equipment to obtain the biomechanics dataset. This also requires the ability to know how to utilize such tools. There is a need to be able to estimate JCFs without using motion capture data.

The field of wearable sensing holds the solution to JCF estimations without motion capture. Recent advances in wearable sensing applications have proven effective at estimating and predicting biological metrics such as kinematics and kinetics [84′], [85′] from wearable sensors and/or motion capture imaging. Ground reaction forces have been shown to correlate to knee joint contact forces [86′] with force plate data. Findings such as these influence the need to develop robust systems for quantifying injury metrics while minimizing the amount of data collected. Among these developments, machine learning has made strides in informing the risk of injury during loading tasks using a wearable system of internal measurement units (IMUs) [90′]. A previous study by Burton et al. (2021) [87′] was among the first to assess the abilities of deep learning models (recurrent, convolutional, and fully connected neural networks) to predict muscle and joint contact forces [87′].

Machine learning has shown promising performance in measuring biological parameters that were once complicated and time-intensive to compute. A growing trend to use wearable sensors such as pressure insoles and/or inertial measurement units (IMUs) to estimate joint moments, internal bone forces [88′], and even injury risks [89′], [90′] is paving a way to probe the relationship between injury mitigation and internal joint contact forces. However, the study still did not know much about the most robust and widely applicable model to achieve such goals.

The purpose of this study was to explore the intersectionality of wearable sensing and machine learning and to facilitate the estimation of JCFs in the knee during dynamic, manual labor tasks. To bridge this gap, the study developed an analysis operation utilizing a dataset [61′] comprised of a diverse set of walking, lifting, squatting, lunging, stair climbing, etc., which replicated the vast assortment of movements encountered every day in the workplace or everyday society. This data was previously collected and processed to extract JCFs as subject-dependent ground truth. With the joint kinematics, which was also output from the musculoskeletal pipeline used to capture JCFs [91′], the study simulated segment linear accelerations, angular velocities, and Euler angles. The study transformed vertical and shear ground reaction forces and center of pressure (mediolateral and anteroposterior) into the foot frame to replicate data streamed from pressure insoles from force plate data. The study then applied a deep learning model on 8 permutations of sensor input combinations between EMG, IMUs, and insoles (and a single super insole version) to estimate normal and shear JCFs (a total of 16 models). The study hypothesized that the combination of IMUs and insoles may provide a reliable estimation of normal and shear knee JCFs (R²>0.7) (H1). Previous studies exploring the utility of wearable sensors find them reliable as a form of injury mitigation and musculoskeletal health monitoring [92′]. Due to intersubject variability in EMG signals [93′], the study expected that the EMG may not be useful for the TCN to map to JCFs, despite the relationship between muscle forces and JCFs. This essential mapping of joint kinematics, ground reaction forces, and, potentially, electromyography (EMG) to joint contact forces may help identify the best practices for training machine learning models and the minimum input required for reliable estimation of joint contact forces across different manual task sets. Investigating the effects of different sensor inputs on JCF estimation across various tasks on multi-joint internal joint loading may enable the field to move forward with reduced sensor sets to estimate JCFs in environments outside the lab. In doing so, the study hoped wearable sensing systems in conjunction with machine learning can provide a greater awareness of the susceptibility to eventual tissue and bone-damaging JCFs, and ultimately injuries, in the workplace.

The study hypothesized that combining IMUs and insoles as inputs to the exemplary system may estimate knee JCFs with a performance of R²>0.7137. After the experiments, the study rejected this hypothesis, as EMG was necessary to accomplish this goal.

Because the knee is a lower-limb joint, the study anticipated that the lower-limb and torso segment kinematics and vertical GRFs may provide sufficient information to map from the simulated inputs to the normal and shear knee JCF ground truths (H1). Work by Stetter et al. (2019) [68′] showcased the success of IMUs in estimating knee joint forces (joint moments) in a two-sensor setup. Sancho-Bru et al. (2023) [69′] showed the ability to capture foot contact forces using pressure insoles. A study by Elstub et al., (2022) [88′] demonstrates the success of estimating tibial bone forces using an IMU and pressure insole. Altogether, these efforts supported the hypothesis that IMU and insole-informed machine learning JCF estimates may be a reliable sensing system for normal and shear JCFs. In actuality, the study found that models trained with EMG in their combinations all provided reliable normal JCF estimates (R²>0.7). Previous studies have shown the intra and intersubject variability in EMG, which the study believed may hinder the ability to estimate JCFs. However, the study believed using subject-dependent ground truth data for model training can lead to its success in improving normal knee JCF estimates.

FIG. 12F shows the normal knee joint contact force estimation using real sensor inputs. FIG. 12F, subpanel (a) shows the average R² value across all tasks using IMU, insoles, and MG sensors. FIG. 12F, subpanel (b) shows knee joint angles during a single gait cycle from a representative participant, aligned with time series tracking of normal JCFs compared to the ground truth. In FIG. 12F, in a time series tracking of normal knee JCFs during lifting tasks, the EMG-only estimate was the only version that maintained satisfactory JCF tracking even through the nuances of the ground truth with changing knee flexion angles, especially knee flexion.

The addition of other sensor types did not improve the model's performance captured as R² or RMSE values (FIGS. 12A-12F). Too much data may be inputted into the TCN model, which may negatively influence how the TCN identifies patterns. Therefore, to further improve normal knee JCF estimation, the next task may be to investigate which subset of muscle activations as input channels to the TCN was necessary to obtain similar performance.

The study also rejected the hypothesis (H1) that IMUs and insoles can estimate shear knee JCFs with an R² of at least 0.7. None of the sensor configurations provided a strong estimation capability. Giarmatzis et al. (2020) [70′] predicted knee JCFs in walking at varying speeds using an ANN and a support vector regression model while inputting kinematic and kinetic data [70′]. Their predictions performed well with moderate to strong Pearson R values (0.45-0.85) with a leave-one-out cross-validation [66′] approach and observed good knee JCF predictions without using ground reaction forces [70′]. One aspect to consider was their use of motion capture, whereas the exemplary system was wearable sensor based—but modeled with simulated IMUs and insoles with experimental EMG as inputs. Additionally, the shear forces in most tasks used (except e.g., cutting) were not very large. Consequently, the model may not track shear knee JCFs across these different tasks due to the subtle changes or inability to relate the sensor channel inputs to those small magnitudes.

The poor performance of the TCN model in estimating shear knee JCFs proposes a few recommendations for future studies. First, the goal was to find and implement mitigation technologies which can reduce hazardous peak and cumulative joint loading. Informing employees about the injury risk associated with a certain work tasks may not be contingent upon continuous monitoring of JCFs—the study placed higher priority on alerting workers about large joint loads and prolonged exposure to these loads. Therefore, there was a need to discover if reducing datapoints to concentrate the model's estimation on peak and/or cumulative loading may lead to changes in its performance, especially in its potential transition into a biofeedback paradigm. Second, moving forward with a sensing system comprised of EMGs, IMUs, and insoles may be overkill. Seeing the promising and useful results that EMG alone can provide regarding normal knee JCFs, running additional machine learning-based estimations, and developing various prototypes of wearable sensing suits with a minimized amount of sensors (e.g., not all seven EMG) can be imperative to know how practical and deployable this mitigation strategy can be for the workplace and everyday wear.

The study sought to test the ability of the strongest performing trained model (all sensors, estimating normal knee JCFs) to estimate normal knee JCFs with the use of all real sensors. The study saw that an estimation ability of R²=0.86 plunges to R²=0.26 and failed to uphold its ability to track knee JCFs temporally (FIG. 12G). This highlighted the poor ability of the TCN model that was trained on simulated sensor data to map JCFs computed with real sensors as inputs instead. Thus, emphasizing the need for advanced machine learning methodologies such as transfer learning to find the proper transform from simulated to real sensor data and boost this model's overall utility in estimating JCFs.

### Discussion

Real-time wearable sensing may revolutionize the fields of biomechanics and wearable robotics by enabling data collection in real-world settings beyond the limitations of traditional lab environments. This framework preserves natural movement patterns and provides near-instantaneous biomechanical feedback, enabling wearable robots or biofeedback systems to act on real-time information. Additionally, it reduces the post-processing time needed to achieve usable data. Due to these advantages, previous studies developed devices and methods for wearable biomechanics sensing [1], [2]. However, none can replicate the consistency and accuracy of motion capture and force plates, which remain the state-of-the-art method for characterizing human movement [3]. Most studies still use cameras and force plates when inverse dynamics are desired.

Many wearable systems that rely on analytical methods for calculating joint states have been attempted. For kinematic sensing, angular measurement via strain sensors [4], [5] and via IMUs [6], [7] have been investigated. However, none have performed with joint angle root mean square error (RMSE) below 5°, which is the standard for most applications [8]. For joint moment tracking, EMG-driven forward dynamics methods have been attempted [9], [10]; however, EMG is variable across individuals and experimental sessions, making repeatable estimates of muscle forces from EMG sensors a challenge [11-13]. Analytical inverse dynamics methods that attempt to infer all of the information typically provided by force plates (3 DOF forces and 3 DOF moments) from pressure insoles using simplistic models have also been attempted [14-16]. However, these methods generalize poorly to new tasks and users and cannot rely on fully wearable kinematic tracking because joint-to-joint error propagation throws off joint moment results when moving up in the proximal chain from the ground. Of all these methods, IMUs and pressure insoles appear to be the most reliable wearable sensor combination for quantifying kinematics and kinetics, respectively. However, analytical methods alone may not be sufficient for wearable biomechanics sensing.

Machine learning has been able to surpass the shortcomings of analytical methods by its ability to find underlying patterns within time-series sensor data. Techniques including extreme gradient boosting (XGBoost), neural networks (NNs), convolutional neural networks (CNNs), temporal convolutional networks (TCNs), recurrent neural networks (RNNs), long short-term memory networks (LSTMs), and transformers have been shown to estimate joint states [17-25]. These approaches have succeeded using only inertial- and force-sensing wearable device data. However, existing work is limited in terms of the estimated number of joints and constituent states and the number of task types investigated. Furthermore, much of the work in this area involves devices that are complicated to don or require precise sensor placement, both of which are drawbacks to real-world implementation. Thus, to enable accessible real-time estimates of complex joint states, the capabilities of a combined deep learning model and robust, easy-to-use sensing system should be developed.

The instant study developed an open-source wearable sensing suit that utilizes IMUs and pressure insoles, as well as a deep learning approach, to be a practical solution for characterizing lower-body biomechanics in real-world scenarios. Then, the instant study compared the joint state estimates from this approach to analytical methods of quantifying the same joint states from wearable sensors. The instant study hypothesized that the deep learning approach can outperform analytical methods on a user-independent, task-agnostic basis because it can account for sensor inaccuracy and inconsistency.

Deep-learning versus Analytical Estimates of Body-Joint Dynamics. Deep learning-based body-joint state estimates outperforming analytically derived joint states was shown in Figs. [ ]-[ ]. There were no joint states for any task type where analytically derived joint states had lower RMSE than TCN estimates. Furthermore, the only joint state for which the TCN did not have lower overall RMSE values was ankle angle, and only in a few tasks. Even with some of the best MEMS IMUs, combined with an accurate pressure insole and providing ground truth values for shear forces and twist-axis moments, analytical inverse dynamics was inaccurate for real-world deployment. However, the results presented here show that incorporating end-to-end deep learning, thereby eliminating challenges associated with shear sensing and avoiding an approach prone to error propagation, can lead to reasonable inverse dynamics that are user-independent and task-agnostic (e.g., highly generalizable).

Second Skin Sensing Performance versus State of the Art. Figueiredo et al. achieved R² values of 0.92, 0.94, and 0.87 for sagittal hip, knee, and ankle angles, respectively, during walking [25], compared to R² values of 0.94, 0.96, and 0.82 on the walking tasks in the instant study. However, the exemplary system did not rely on sensor placement and task-specific models. Hernandez et al. was able to achieve mean absolute errors (MAE) for walking and running of 3.7°, 2.9°, and 5.1° at the hip, knee, and ankle, respectively, without relying on precise sensor placement [32]. This slightly outperformed the exemplary system's MAE for walking of 6.1°, 4.7°, and 4.2° at the hip, knee, and ankle. However, Hernandez et al. included a larger and more homogeneous population of 27 males, with no females, and only had to perform well on two gaits. Overall, the exemplary system's performance was in line with the current state-of-the-art for wearable kinematic sensing as its accuracy was in line with the best systems shown in previous studies, and the exemplary system demonstrated the generalization on a wider task set than systems shown in previous studies.

The exemplary system can estimate joint moments in a task-agnostic, subject-independent manner. The only state-of-the-art system to have implemented this successfully was Molinaro et al. [29]. Molinaro et al. achieved RMSE of 0.15 Nm/kg and 0.13 Nm/kg for cyclic tasks and 0.21 Nm/kg and 0.16 Nm/kg for non-cyclic tasks at the hip and knee, respectively. The exemplary system generated 0.22 Nm/kg and 0.22 Nm/kg for walking and 0.21 Nm/kg and 0.17 Nm/kg for non-cyclic tasks at the hip and knee, respectively. The exemplary system was outperformed in terms of RMSE in walking by Molinaro et al., but had the same result for non-cyclic tasking. The exemplary system showed worse results for cyclic tasks than non-cyclic tasks, contrary to what Molinaro et al. observed, which can be due to the dataset in the instant study having little cyclical data compared to the dataset used in Molinaro et al. (FIG. 10M subpanel (b)). The exemplary system has two advantages over Molinaro et al.: its functionality at more joints (ankle and lower back) and the fact that it was developed to be a sensing suite that was compatible with biofeedback systems and wearable robots. Additionally, the sensors of the exemplary system were on the human body (rather than on an exoskeleton), providing deployability across different wearable devices and contexts outside wearable robotics, such as biofeedback training and out-of-the-lab biomechanics collections.

Challenges for Analytical Inverse Dynamics in Wearables. The instant study's analytically derived inverse dynamics results showed worse performance moving proximally from the ground. This can be due to kinematic error propagating from joint to joint, which was not an issue experienced in the end-to-end deep learning method in the instant study. A similar trend was seen in both Liu et al. and Khurelbaatar et al. where inverse dynamics and kinematics were solved from the ground up, and dynamics error propagated in the same direction [15], [16]. In these previous studies, however, optical kinematic tracking was employed, which cut down on kinematic error, suggesting that analytical methods for ground-up inverse dynamics alone may be insufficient with the current state-of-the-art for wearable kinematic tracking. Other analytical models, like top-down approaches, can be considered for analytical models of proximal joints (e.g., the back and hip) [33].

Limitations. There were a few limitations to the exemplary system in the instant study. Previous success in estimating joint moments showed a strong performance when including joint angles as an input, often from motor encoders. Because the study preferred deploying a sensing system that can function without outputs from exos, the study preferred a model that did not require additional information to succeed. However, it is possible that knee joint angles could have allowed the model to estimate normal and shear JCFs better. Another limitation was blending datasets, which only contained lifting tasks, and a larger dataset, which contains 25+ diverse task types. Initially, the study feared that the model may overfit for the lifting conditions; however, the study found the two lifting-only datasets did not provide enough data points for overfitting. The model may perform even better if all individuals had data from each task type. In preliminary validation analyses using the dynamic task set, the study saw a decrease in the model's ability to estimate joint moments when including the two lifting-only datasets in the training datasets. The addition of data for only one task may be hurting the overall performance of the model in JCFs estimations.

### CONCLUSION

Computer-executable instructions, such as program modules, being executed by a computer may be used. Generally, program modules include routines, programs, objects, components, data structures, etc., that perform particular tasks or implement particular abstract data types. In its most basic configuration, the controller includes at least one processing unit and memory. Depending on the exact configuration and type of computing device, memory may be volatile (such as random-access memory (RAM)), non-volatile (such as read-only memory (ROM), flash memory, etc.), or some combination of the two. The controller may have additional features/functionality.

It should be understood that the various techniques described herein may be implemented in connection with hardware components or software components or, where appropriate, with a combination of both. Illustrative types of hardware components that can be used include Field-programmable Gate Arrays (FPGAs), Application-specific Integrated Circuits (ASICs), Application-specific Standard Products (ASSPs), System-on-a-chip systems (SOCs), Complex Programmable Logic Devices (CPLDs), etc. The methods and apparatus of the presently disclosed subject matter, or certain aspects or portions thereof, may take the form of program code (i.e., instructions) embodied in tangible media, such as floppy diskettes, CD-ROMs, hard drives, or any other machine-readable storage medium where, when the program code is loaded into and executed by a machine, such as a computer, the machine becomes an apparatus for practicing the presently disclosed subject matter.

Although exemplary implementations may refer to utilizing aspects of the presently disclosed subject matter in the context of one or more stand-alone computer systems, the subject matter is not so limited but rather may be implemented in connection with any computing environment, such as a network or distributed computing environment. Still further, aspects of the presently disclosed subject matter may be implemented in or across a plurality of processing chips or devices, and storage may similarly be implemented across a plurality of devices. Such devices might include personal computers, network servers, handheld devices, and wearable devices, for example.

Although example embodiments of the present disclosure are explained in some instances in detail herein, it is to be understood that other embodiments are contemplated. Accordingly, it is not intended that the present disclosure be limited in its scope to the details of construction and arrangement of components set forth in the following description or illustrated in the drawings. The present disclosure is capable of other embodiments and of being practiced or carried out in various ways.

It must also be noted that, as used in the specification and the appended claims, the singular forms “a,” “an,” and “the” include plural referents unless the context clearly dictates otherwise. Ranges may be expressed herein as from “about” or “5 approximately” one particular value and/or to “about” or “approximately” another particular value. When such a range is expressed, other exemplary embodiments include from the one particular value and/or to the other particular value.

By “comprising” or “containing” or “including” is meant that at least the name compound, element, particle, or method step is present in the composition or article or method, but does not exclude the presence of other compounds, materials, particles, method steps, even if the other such compounds, material, particles, method steps have the same function as what is named.

In describing example embodiments, terminology will be resorted to for the sake of clarity. It is intended that each term contemplates its broadest meaning as understood by those skilled in the art and includes all technical equivalents that operate in a similar manner to accomplish a similar purpose. It is also to be understood that the mention of one or more steps of a method does not preclude the presence of additional method steps or intervening method steps between those steps expressly identified. Steps of a method may be performed in a different order than those described herein without departing from the scope of the present disclosure. Similarly, it is also to be understood that the mention of one or more components in a device or system does not preclude the presence of additional components or intervening components between those components expressly identified.

The term “about,” as used herein, means approximately, in the region of, roughly, or around. When the term “about” is used in conjunction with a numerical range, it modifies that range by extending the boundaries above and below the numerical values set forth. In general, the term “about” is used herein to modify a numerical value above and below the stated value by a variance of 10%. In one aspect, the term “about” means plus or minus 10% of the numerical value of the number with which it is being used. Therefore, about 50% means in the range of 45%-55%. Numerical ranges recited herein by endpoints include all numbers and fractions subsumed within that range (e.g., 1 to 5 includes 1, 1.5, 2, 2.75, 3, 3.90, 4, 4.24, and 5).

Similarly, numerical ranges recited herein by endpoints include subranges subsumed within that range (e.g., 1 to 5 includes 1-1.5, 1.5-2, 2-2.75, 2.75-3, 3-3.90, 3.90-4, 4-4.24, 4.24-5, 2-5, 3-5, 1-4, and 2-4). It is also to be understood that all numbers and fractions thereof are presumed to be modified by the term “about.”

The following patents, applications and publications as listed below and throughout this document are hereby incorporated by reference in their entirety herein.

### REFERENCE LIST #1

[1] C. Wong, Z.-Q. Zhang, B. Lo, and G.-Z. Yang, “Wearable Sensing for Solid Biomechanics: A Review,” IEEE Sens. J., vol. 15, no. 5, pp. 2747-2760 May 2015, doi: 10.1109/JSEN.2015.2393883.
[2] D. T.-P. Fong and Y.-Y. Chan, “The Use of Wearable Inertial Motion Sensors in Human Lower Limb Biomechanics Studies: A Systematic Review,” Sensors, vol. 10, no. 12, Art. no. 12, December 2010, doi: 10.3390/s101211556.
[3] D. G. E. Robertson, G. E. Caldwell, J. Hamill, G. Kamen, and S. Whittlesey, Research Methods in Biomechanics. Human Kinetics, 2013.
[4] Y. Menguc et al., “Soft Wearable Motion Sensing Suit for Lower Limb Biomechanics Measurements.”
[5] G. Frediani, B. Botondi, L. Quartini, G. Zonfrillo, L. Bocchi, and F. Carpi, “Wearable Kinematic Monitoring System Based on Piezocapacitive Sensors,” Stud. Health Technol. Inform., vol. 261, pp. 103-108, 2019.
[6] P. Slade, A. Habib, J. L. Hicks, and S. L. Delp, “An Open-Source and Wearable System for Measuring 3D Human Motion in Real-Time,” IEEE Trans. Biomed. Eng., vol. 69, no. 2, pp. 678-688, February 2022, doi: 10.1109/TBME.2021.3103201.
[7] L. Sy et al., “Estimating Lower Limb Kinematics Using a Reduced Wearable Sensor Count,” IEEE Trans. Biomed. Eng., vol. 68, no. 4, pp. 1293-134 April 2021, doi: 10.1109/TBME.2020.3026464.
[8] J. L. McGinley, R. Baker, R. Wolfe, and M. E. Morris, “The reliability of three-dimensional kinematic gait measurements: a systematic review,” Gait Posture, vol. 29, no. 3, pp. 360-369, April 2009, doi: 10.1016/j.gaitpost.2008.09.003.
[9] T. S. Buchanan, D. G. Lloyd, K. Manal, and T. F. Besier, “Estimation of Muscle Forces and Joint Moments Using a Forward-Inverse Dynamics Model,” Med. Sci. Sports Exerc., vol. 37, no. 11, p. 1911 November 2005, doi: 10.1249/01.mss.0000176684.24008.6f.
[10] M. Sartori, M. Reggiani, D. Farina, and D. G. Lloyd, “EMG-Driven Forward-Dynamic Estimation of Muscle Force and Joint Moment about Multiple Degrees of Freedom in the Human Lower Extremity,” PLOS ONE, vol. 7, no. 12, p. e52618, December 2012, doi: 10.1371/journal.pone.0052618.
[11] D. Staudenmann, I. Kingma, A. Daffertshofer, D. F. Stegeman, and J. H. van Dieën, “Improving EMG-based muscle force estimation by using a high-density EMG grid and principal component analysis,” IEEE Trans. Biomed. Eng., vol. 53, no. 4, pp. 712-719, April 2006, doi: 10.1109/TBME.2006.870246.
[12] Q. Shao, D. N. Bassett, K. Manal, and T. S. Buchanan, “An EMGdriven model to estimate muscle forces and joint moments in stroke patients,” Comput. Biol. Med., vol. 39, no. 12, pp. 1083-188 December 2009, doi: 10.1016/j.compbiomed.2009.09.002.
[13] U. J. Naeem, C. Xiong, and A. A. Abdullah, “EMG-muscle force estimation model based on back-propagation neural network,” 2012 IEEE Int. Conf. Virtual Environ. Hum.-Comput. Interfaces Meas. Syst. VECIMS Proc., 2012, Accessed: Aug. 20, 2024. [Online]. Available: https://www.semanticscholar.org/paper/EMG-muscle-force-estimationmodel-based-on-neural-NaeemXiong/1345379d1c54d764fdf7f353e5de0b88bf25b654
[14] D. A. Jacobs and D. P. Ferris, “Estimation of ground reaction forces and ankle moment with multiple, low-cost sensors,” J. NeuroEngineering Rehabil., vol. 12, no. 1, p. 90, October 2015, doi: 10.1186/s12984-015-0081-x.
[15] T. Khurelbaatar, K. Kim, S. Lee, and Y. H. Kim, “Consistent accuracy in whole-body joint kinetics during gait using wearable inertial motion sensors and in-shoe pressure sensors,” Gait Posture, vol. 42, no. 1, pp. 65-69, June 2015, doi: 10.1016/j.gaitpost.2015.04.007.
[16] T. Liu, Y. Inoue, K. Shibata, K. Shiojima, and M. M. Han, “Triaxial joint moment estimation using a wearable three-dimensional gait analysis system,” Measurement, vol. 47, pp. 125-129, January 2014, doi: 10.1016/j.measurement.2013.08.020.
[17] C. Wang et al., “Real-Time Estimation of Knee Adduction Moment for Gait Retraining in Patients With Knee Osteoarthritis,” IEEE Trans. Neural Syst. Rehabil. Eng., vol. 28, no. 4, pp. 888-894, April 2020, doi: 10.1109/TNSRE.2020.2978537.
[18] X. Jiang, M. Gholami, M. Khoshnam, J. J. Eng, and C. Menon, “Estimation of Ankle Joint Power during Walking Using Two Inertial Sensors,” Sensors, vol. 19, no. 12, Art. no. 12, January 2019, doi: 10.3390/s19122796.
[19] G. Ding, I. Georgilas, and A. Plummer, “A Deep Learning Model with a Self-Attention Mechanism for Leg Joint Angle Estimation across Varied Locomotion Modes,” Sensors, vol. 24, no. 1, Art. no. 1, January 2024, doi: 10.3390/s24010211.
[20] M. Mundt, W. R. Johnson, W. Potthast, B. Markert, A. Mian, and J. Alderson, “A Comparison of Three Neural Network Approaches for Estimating Joint Angles and Moments from Inertial Measurement Units,” Sensors, vol. 21, no. 13, Art. no. 13, January 2021, doi: 10.3390/s21134535.
[21] F. Wang et al., “Estimation of Lower Limb Joint Angles and Joint Moments during Different Locomotive Activities Using the Inertial Measurement Units and a Hybrid Deep Learning Model,” Sensors, vol. 23, no. 22, Art. no. 22, January 2023, doi: 10.3390/s23229039.
[22] Y. Zhu, D. Xia, and H. Zhang, “Using Wearable Sensors to Estimate Vertical Ground Reaction Force Based on a Transformer,” Appl. Sci., vol. 13, no. 4, Art. no. 4, January 2023, doi: 10.3390/app 13042136.
[23] S. Chae, A. Choi, H. Jung, T. H. Kim, K. Kim, and J. H. Mun, “Machine Learning Model to Estimate Net Joint Moments during Lifting Task Using Wearable Sensors: A Preliminary Study for Design of Exoskeleton Control System,” Appl. Sci., vol. 11, no. 24, Art. no. 24, January 2021, doi: 10.3390/app 112411735.
[24] D. D. Molinaro, I. Kang, J. Camargo, M. C. Gombolay, and A. J. Young, “Subject-Independent, Biological Hip Moment Estimation During Multimodal Overground Ambulation Using Deep Learning,” IEEE Trans. Med. Robot. Bionics, vol. 4, no. 1, pp. 219-229, February 2022, doi: 10.1109/TMRB.2022.3144025.
[25] J. Figueiredo, S. P. Carvalho, J. P. Vilas-Boas, L. M. Gonçalves, J. C. Moreno, and C. P. Santos, “Wearable Inertial Sensor System towards Daily Human Kinematic Gait Analysis: Benchmarking Analysis to MVN BIOMECH,” Sensors, vol. 20, no. 8, Art. no. 8, January 2020, doi: 10.3390/s20082185.
[26] D. D. Molinaro, I. Kang, and A. J. Young, “Estimating human joint moments unifies exoskeleton control, reducing user effort,” Sci. Robot., vol. 9, no. 88, p. eadi8852, March 2024, doi: 10.1126/scirobotics.adi8852.
[27] S. L. Delp et al., “OpenSim: Open-Source Software to Create and Analyze Dynamic Simulations of Movement,” IEEE Trans. Biomed. Eng., vol. 54, no. 11, pp. 1940-1950 November 2007, doi: 10.1109/TBME.2007.901024.
[28] S. Bai, J. Z. Kolter, and V. Koltun, “An Empirical Evaluation of Generic Convolutional and Recurrent Networks for Sequence Modeling,” Apr. 19, 2018, arXiv: arXiv:1803.01271. Accessed: Aug. 20, 2024. [Online]. Available: 1803.01271.
[29] D. D. Molinaro, K. Scherpereel, E. B. Schonhaut, G. Evangelopoulos, M. K. Shepherd, and A. J. Young, “Task-Agnostic Exoskeleton Control via Biological Joint Moment Estimation,” Nature, vol. (In Press), 2024.
[30] A. Paszke et al., “PyTorch: An Imperative Style, High-Performance Deep Learning Library,” in Advances in Neural Information Processing Systems, Curran Associates, Inc., 2019. Accessed: Oct. 10, 2023. [Online]. Available: https://papers.nips.cc/paper_files/paper/2019/hash/bdbca288fee7f92f2bf a9f7012727740-Abstract.html
[31] X. Glorot, A. Bordes, and Y. Bengio, “Deep Sparse Rectifier Neural Networks,” in Proceedings of the Fourteenth International Conference on Artificial Intelligence and Statistics, JMLR Workshop and Conference Proceedings, June 2011, pp. 315-323. Accessed: Oct. 10, 2023. [Online]. Available: https://proceedings.mlr.press/v15/glorot11a.html
[32] V. Hernandez, D. Dadkhah, V. Babakeshizadeh, and D. Kulić, “Lower body kinematics estimation from wearable sensors for walking and running: A deep learning approach,” Gait Posture, vol. 83, pp. 185-193, January 2021, doi: 10.1016/j.gaitpost.2020.10.026.
[33] Y. Iino and T. Kojima, “Validity of the top-down approach of inverse dynamics analysis in fast and large rotational trunk movements,” J. Appl. Biomech., vol. 28, no. 4, pp. 420-430, August 2012, doi: 10.1123/jab.28.4.420.
[34] M. I. Jordan and T. M. Mitchell, “Machine learning: Trends, perspectives, and prospects,” Science, vol. 349, no. 6245, pp. 255-260, July 2015, doi: 10.1126/science.aaa8415.

### REFERENCE LIST #2

[1′] L. N. Jessup, L. A. Kelly, A. G. Cresswell, and G. A. Lichtwark, “Linking muscle mechanics to the metabolic cost of human hopping,” Journal of Experimental Biology, vol. 226, no. 12, p. jeb245614, June 2023, doi: 10.1242/jeb.245614.
[2′] J. Ueda, D. Ming, V. Krishnamoorthy, M. Shinohara, and T. Ogasawara, “Individual Muscle Control Using an Exoskeleton Robot for Muscle Function Testing,” IEEE Transactions on Neural Systems and Rehabilitation Engineering, vol. 18, no. 4, pp. 339-350, August 2010, doi: 10.1109/TNSRE.2010.2047116.
[3′] A. Erdemir, S. McLean, W. Herzog, and A. J. van den Bogert, “Model-based estimation of muscle forces exerted during movements,” Clinical Biomechanics, vol. 22, no. 2, pp. 131-154, February 2007, doi: 10.1016/j.clinbiomech.2006.09.005.
[4′] F. Schellenberg, K. Oberhofer, W. R. Taylor, and S. Lorenzetti, “Review of Modelling Techniques for In Vivo Muscle Force Estimation in the Lower Extremities during Strength Training,” Computational and Mathematical Methods in Medicine, vol. 2015, p. e483921, August 2015, doi: 10.1155/2015/483921.
[5′] C. N. Christakos, “A study of the muscle force waveform using a population stochastic model of skeletal muscle,” Biol. Cybernetics, vol. 44, no. 2, pp. 91-106, July 1982, doi: 10.1007/BF00317969.
[6′] S. Martelli, D. Calvetti, E. Somersalo, M. Viceconti, and F. Taddei, “Computational tools for calculating alternative muscle force patterns during motion: A comparison of possible solutions,” Journal of Biomechanics, vol. 46, no. 12, pp. 2097-210 August 2013, doi: 10.1016/j.jbiomech.2013.05.023.
[7′] S. Martelli, D. Calvetti, E. Somersalo, and M. Viceconti, “Stochastic modelling of muscle recruitment during activity,” Interface Focus, vol. 5, no. 2, p. 20140094, April 2015, doi: 10.1098/rsfs.2014.0094.
[8′] F. C. Anderson and M. G. Pandy, “Static and dynamic optimization solutions for gait are practically equivalent,” Journal of Biomechanics, vol. 34, no. 2, pp. 153-161, February 2001, doi: 10.1016/S0021-9290(00)00155-X.
[9′] R. D. Crowninshield and R. A. Brand, “A physiologically based criterion of muscle force prediction in locomotion,” Journal of Biomechanics, vol. 14, no. 11, pp. 793-801, January 1981, doi: 10.1016/0021-9290(81)90035-X.
[10′] S. L. Delp et al., “OpenSim: Open-Source Software to Create and Analyze Dynamic Simulations of Movement,” IEEE Transactions on Biomedical Engineering, vol. 54, no. 11, pp. 1940-1950 November 2007, doi: 10.1109/TBME.2007.901024.
[11′] C. Pizzolato et al., “CEINMS: A toolbox to investigate the influence of different neural control solutions on the prediction of muscle excitation and joint moments during dynamic motor tasks,” Journal of Biomechanics, vol. 48, no. 14, pp. 3929-3936 November 2015, doi: 10.1016/j.jbiomech.2015.09.021.
[12′] D. G. Lloyd and T. F. Besier, “An EMG-driven musculoskeletal model to estimate muscle forces and knee joint moments in vivo,” Journal of Biomechanics, vol. 36, no. 6, pp. 765-776, June 2003, doi: 10.1016/S0021-9290(03)00010-1.
[13′] H. X. Hoang, L. E. Diamond, D. G. Lloyd, and C. Pizzolato, “A calibrated EMG-informed neuromusculoskeletal model can appropriately account for muscle co-contraction in the estimation of hip joint contact forces in people with hip osteoarthritis,” Journal of Biomechanics, vol. 83, pp. 134-142, January 2019, doi: 10.1016/j.jbiomech.2018.11.042.
[14′] L. L. Menegaldo, L. F. de Oliveira, and K. K. Minato, “EMGD-FE: an open source graphical user interface for estimating isometric muscle forces in the lower limb using an EMG-driven model,” BioMedical Engineering OnLine, vol. 13, no. 1, p. 37, April 2014, doi: 10.1186/1475-925X-13-37.
[15′] G. Durandau, D. Farina, and M. Sartori, “Robust Real-Time Musculoskeletal Modeling Driven by Electromyograms,” IEEE Transactions on Biomedical Engineering, vol. 65, no. 3, pp. 556-564, March 2018, doi: 10.1109/TBME.2017.2704085.
[16′] M. Sartori, M. Reggiani, D. Farina, and D. G. Lloyd, “EMG-Driven Forward-Dynamic Estimation of Muscle Force and Joint Moment about Multiple Degrees of Freedom in the Human Lower Extremity,” PLOS ONE, vol. 7, no. 12, p. e52618, December 2012, doi: 10.1371/journal.pone.0052618.
[17′] M. Sartori, D. Farina, and D. G. Lloyd, “Hybrid neuromusculoskeletal modeling to best track joint moments using a balance between muscle excitations derived from electromyograms and optimization,” Journal of Biomechanics, vol. 47, no. 15, pp. 3613-3621 November 2014, doi: 10.1016/j.jbiomech.2014.10.009.
[18′] J. Heino, D. Calvetti, and E. Somersalo, “Metabolica: a statistical research tool for analyzing metabolic networks,” Comput Methods Programs Biomed, vol. 97, no. 2, p. 151, February 2010, doi: 10.1016/j.cmpb.2009.07.007.
[19′] K. J. Bennett et al., “EMG-Informed Neuromusculoskeletal Models Accurately Predict Knee Loading Measured Using Instrumented Implants,” IEEE Trans. Biomed. Eng., vol. 69, no. 7, pp. 2268-2275 July 2022, doi: 10.1109/TBME.2022.3141067.
[20′] “Getting Started with Static Optimization-OpenSim Documentation-OpenSim.” Accessed: Mar. 28, 2024. [Online]. Available: https://opensimconfluence.atlassian.net/wiki/spaces/OpenSim/pages/5 3089624/Getting+Started+with+Static+Optimization
[21′] J. Han, Q. Ding, A. Xiong, and X. Zhao, “A State-Space EMG Model for the Estimation of Continuous Joint Movements,” IEEE Trans. Ind. Electron., vol. 62, no. 7, pp. 4267-4275 July 2015, doi: 10.1109/TIE.2014.2387337.
[22′] Q. Ding, J. Han, and X. Zhao, “Continuous Estimation of Human Multi-Joint Angles From sEMG Using a State-Space Model,” IEEE Trans. Neural Syst. Rehabil. Eng., vol. 25, no. 9, pp. 1518-1528 September 2017, doi: 10.1109/TNSRE.2016.2639527.
[23′] A. Navacchia, D. R. Hume, P. J. Rullkoetter, and K. B. Shelburne, “A computationally efficient strategy to estimate muscle forces in a finite element musculoskeletal model of the lower limb,” Journal of Biomechanics, vol. 84, pp. 94-102, February 2019, doi: 10.1016/j.jbiomech.2018.12.020.
[24′] R. D. Gurchiek, N. Cheney, and R. S. McGinnis, “Estimating Biomechanical Time-Series with Wearable Sensors: A Systematic Review of Machine Learning Techniques,” Sensors, vol. 19, no. 23, p. 5227 November 2019, doi: 10.3390/s19235227.
[25′] J. Bae, K. Kong, and M. Tomizuka, “Real-time Estimation of Lower Extremity Joint Torques in Normal Gait,” IFAC Proceedings Volumes, vol. 42, no. 16, pp. 443-448, 2009, doi: 10.3182/20090909-4-JP-2010.00076.
[26′] S. E. Oh, A. Choi, and J. H. Mun, “Prediction of ground reaction forces during gait based on kinematics and a neural network model,” Journal of Biomechanics, vol. 46, no. 14, pp. 2372-2380 September 2013, doi: 10.1016/j.jbiomech.2013.07.036.
[27′] B. J. Stetter, F. C. Krafft, S. Ringhof, T. Stein, and S. Sell, “A Machine Learning and Wearable Sensor Based Approach to Estimate External Knee Flexion and Adduction Moments During Various Locomotion Tasks,” Frontiers in Bioengineering and Biotechnology, vol. 8, 2020, Accessed: Nov. 17, 2022. [Online]. Available: https://www.frontiersin.org/articles/10.3389/fbioe.2020.00009
[28′] F. J. Wouda et al., “Estimation of Vertical Ground Reaction Forces and Sagittal Knee Kinematics During Running Using Three Inertial Sensors,” Frontiers in Physiology, vol. 9, 2018, Accessed: Jan. 8, 2024. [Online]. Available: https://www.frontiersin.org/articles/10.3389/fphys.2018.00218
[29′] D. A. Jacobs and D. P. Ferris, “Estimation of ground reaction forces and ankle moment with multiple, low-cost sensors,” Journal of NeuroEngineering and Rehabilitation, vol. 12, no. 1, p. 90, October 2015, doi: 10.1186/s12984-015-0081-x.
[30′] D. D. Molinaro, I. Kang, J. Camargo, and A. J. Young, “Biological Hip Torque Estimation using a Robotic Hip Exoskeleton,” in 2020 8th IEEE RAS/EMBS International Conference for Biomedical Robotics and Biomechatronics (BioRob), November 2020, pp. 791-796. doi: 10.1109/BioRob49111.2020.9224334.
[31′] M. E. Athanasiadou, M. A. Daley, and A. D. Koelewijn, “Neural Networks Estimate Muscle Force in Dynamic Conditions Better than Hill-type Muscle Models,” Mar. 14, 2024, bioRxiv. doi: 10.1101/2024.03.12.584454.
[32′] D. D. Molinaro, I. Kang, J. Camargo, M. C. Gombolay, and A. J. Young, “Subject-Independent, Biological Hip Moment Estimation During Multimodal Overground Ambulation Using Deep Learning,” IEEE Transactions on Medical Robotics and Bionics, vol. 4, no. 1, pp. 219-229, February 2022, doi: 10.1109/TMRB.2022.3144025.
[33′] D. D. Molinaro, I. Kang, and A. J. Young, “Estimating human joint moments unifies exoskeleton control, reducing user effort,” Science Robotics, vol. 9, no. 88, p. eadi8852, March 2024, doi: 10.1126/scirobotics.adi8852.
[34′] D. D. Molinaro, K. Scherpereel, E. B. Schonhaut, G. Evangelopoulos, M. K. Shepherd, and A. J. Young, “Task-Agnostic Exoskeleton Control via Biological Joint Moment Estimation,” Nature, vol. (In Review), 2024.
[35′] K. Scherpereel, D. Molinaro, O. Inan, M. Shepherd, and A. Young, “A human lower-limb biomechanics and wearable sensors dataset during cyclic and non-cyclic activities,” Sci Data, vol. 10, no. 1, Art. no. 1, December 2023, doi: 10.1038/s41597-023-02840-6.
[36′] M. Tiboni, A. Borboni, F. Vérité, C. Bregoli, and C. Amici, “Sensors and Actuation Technologies in Exoskeletons: A Review,” Sensors, vol. 22, no. 3, p. 884, January 2022, doi: 10.3390/s22030884.
[37′] Y.-C. Lin, T. W. Dorn, A. G. Schache, and M. G. Pandy, “Comparison of different methods for estimating muscle forces in human movement,” Proc Inst Mech Eng H, vol. 226, no. 2, pp. 103-112, February 2012, doi: 10.1177/0954411911429401.
[38′] D. G. Thelen, A. Seth, F. C. Anderson, and S. L. Delp, “Gait 2392 and 2354 Models.” OpenSim Documentation, Mar. 26, 2024. [Online]. Available: https://opensimconfluence.atlassian.net/wiki/spaces/OpenSim/pages/5 3086215/Gait+2392+and+2354+Models
[39′] S. Bai, J. Z. Kolter, and V. Koltun, “An Empirical Evaluation of Generic Convolutional and Recurrent Networks for Sequence Modeling,” Apr. 19, 2018, arXiv: arXiv:1803.01271. Accessed: Mar. 26, 2024. [Online]. Available: http://arxiv.org/abs/1803.01271
[40′] Y. He and J. Zhao, “Temporal Convolutional Networks for Anomaly Detection in Time Series,” J. Phys.: Conf. Ser., vol. 1213, no. 4, p. 042050, June 2019, doi: 10.1088/1742-6596/1213/4/042050.
[41′] K. L. Scherpereel, D. D. Molinaro, M. K. Shepherd, O. T. Inan, and A. J. Young, “Improving Biological Joint Moment Estimation During Real-World Tasks with EMG and Instrumented Insoles,” IEEE Trans. Biomed. Eng., (In Review).
[42′] D. Lee, I. Kang, D. D. Molinaro, A. Yu, and A. J. Young, “Real-Time User-Independent Slope Prediction Using Deep Learning for Modulation of Robotic Knee Exoskeleton Assistance,” IEEE Robotics and Automation Letters, vol. 6, no. 2, pp. 3995-40 April 2021, doi: 10.1109/LRA.2021.3066973.
[43′] I. Kang, H. Hsu, and A. Young, “The Effect of Hip Assistance Levels on Human Energetic Cost Using Robotic Hip Exoskeletons,” IEEE Robot. Autom. Lett., vol. 4, no. 2, pp. 430-437, April 2019, doi: 10.1109/LRA.2019.2890896.
[44′] D.-S. Kim et al., “A wearable hip-assist robot reduces the cardiopulmonary metabolic energy expenditure during stair ascent in elderly adults: a pilot cross-sectional study,” BMC Geriatrics, vol. 18, no. 1, p. 230, September 2018, doi: 10.1186/s12877-018-0921-1.
[45′] N. Ball and J. C. Scurr, “Efficacy of current and novel electromyographic normalization methods for lower limb high-speed muscle actions,” European Journal of Sport Science, vol. 11, no. 6, pp. 447-456, November 2011, doi: 10.1080/17461391.2010.536583.
[46′] M. W. Buckthorpe, R. Hannah, T. g. Pain, and J. P. Folland, “Reliability of neuromuscular measurements during explosive isometric contractions, with special reference to electromyography normalization techniques,” Muscle & Nerve, vol. 46, no. 4, pp. 566-576, 2012, doi: 10.1002/mus.23322.
[47′] N. Ball and J. Scurr, “Electromyography Normalization Methods for High-Velocity Muscle Actions: Review and Recommendations,” Journal of Applied Biomechanics, vol. 29, no. 5, pp. 600-608, October 2013, doi: 10.1123/jab.29.5.600.
[48′] S. Göktepe, A. Menzel, and E. Kuhl, “The Generalized Hill Model: A Kinematic Approach Towards Active Muscle Contraction,” J Mech Phys Solids, vol. 72, pp. 20-39, December 2014, doi: 10.1016/j.jmps.2014.07.015.
[49′] D. D. Molinaro, E. O. Park, and A. J. Young, “Anticipation and Delayed Estimation of Sagittal Plane Human Hip Moments using Deep Learning and a Robotic Hip Exoskeleton,” in 2023 IEEE International Conference on Robotics and Automation (ICRA), London, United Kingdom: IEEE, May 2023, pp. 12679-12685. doi: 10.1109/ICRA48891.2023.10161286.
[50′] M. S. B. Hossain, Z. Guo, and H. Choi, “Estimation of Lower Extremity Joint Moments and 3D Ground Reaction Forces Using IMU Sensors in Multiple Walking Conditions: A Deep Learning Approach,” IEEE J. Biomed. Health Inform., vol. 27, no. 6, pp. 2829-2840 June 2023, doi: 10.1109/JBHI.2023.3262164.
[51′] H. Lim, B. Kim, and S. Park, “Prediction of Lower Limb Kinetics and Kinematics during Walking by a Single IMU on the Lower Back Using Machine Learning,” Sensors, vol. 20, no. 1, Art. no. 1, January 2020, doi: 10.3390/s20010130.
[52′] M. Mundt, W. R. Johnson, W. Potthast, B. Markert, A. Mian, and J. Alderson, “A Comparison of Three Neural Network Approaches for Estimating Joint Angles and Moments from Inertial Measurement Units,” Sensors, vol. 21, no. 13, Art. no. 13, January 2021, doi: 10.3390/s21134535.
[53′] A. Kian et al., “Static optimization underestimates antagonist muscle activity at the glenohumeral joint: A musculoskeletal modeling study,” Journal of Biomechanics, vol. 97, p. 109348, December 2019, doi: 10.1016/j.jbiomech.2019.109348.
[54′] J. Camargo, W. Flanagan, N. Csomay-Shanklin, B. Kanwar, and A. Young, “A Machine Learning Strategy for Locomotion Classification and Parameter Estimation Using Fusion of Wearable Sensors,” IEEE Transactions on Biomedical Engineering, vol. 68, no. 5, pp. 1569-1578 May 2021, doi: 10.1109/TBME.2021.3065809.
[55′] E. Trigili et al., “Detection of movement onset using EMG signals for upper-limb exoskeletons in reaching tasks,” J NeuroEngineering Rehabil, vol. 16, no. 1, p. 45, March 2019, doi: 10.1186/s12984-019-0512-1.
[56′] D. Farina et al., “The Extraction of Neural Information from the Surface EMG for the Control of Upper-Limb Prostheses: Emerging Avenues and Challenges,” IEEE Trans. Neural Syst. Rehabil. Eng., vol. 22, no. 4, pp. 797-809, July 2014, doi: 10.1109/TNSRE.2014.2305111.
[57′] O. W. Samuel et al., “Intelligent EMG Pattern Recognition Control Method for Upper-Limb Multifunctional Prostheses: Advances, Current Challenges, and Future Prospects,” IEEE Access, vol. 7, pp. 10150-10165, 2019, doi: 10.1109/ACCESS.2019.2891350.
[58′] J. Camargo, D. Molinaro, and A. Young, “Predicting biological joint moment during multiple ambulation tasks,” Journal of Biomechanics, vol. 134, p. 111020, March 2022, doi: 10.1016/j.jbiomech.2022.111020.
[59′] M. G. Pandy and T. P. Andriacchi, “Muscle and Joint Function in Human Locomotion,” Annu. Rev. Biomed. Eng., vol. 12, no. 1, pp. 401-433, July 2010, doi: 10.1146/annurev-bioeng-070909-105259.
[60′] J. J. Dowling, “The Use of Electromyography for the Noninvasive Prediction of Muscle Forces: Current Issues,” Sports Medicine, vol. 24, no. 2, pp. 82-96, August 1997, doi: 10.2165/00007256-199724020-00002.
[61′] Scherpereel K, Molinaro D, Inan O, Shepherd M, Young A. A human lower-limb biomechanics and wearable sensors dataset during cyclic and non-cyclic activities. Scientific Data. 2023; 10(1):924.
[62′] Stegeman D, Hermens H. Standards for surface electromyography: The European project Surface EMG for non-invasive assessment of muscles (SENIAM). Enschede: Roessingh Research and Development. 2007; 10:8-12.
[63′] Delp S L, Anderson F C, Arnold A S, et al. OpenSim: Open-Source Software to Create and Analyze Dynamic Simulations of Movement. IEEE Trans Biomed Eng. 2007; 54(11):1940-1950. doi: 10.1109/TBME.2007.901024
[64′] Pizzolato C, Lloyd D G, Sartori M, et al. CEINMS: A toolbox to investigate the influence of different neural control solutions on the prediction of muscle excitation and joint moments during dynamic motor tasks. Journal of biomechanics. 2015; 48(14):3929-3936.
[65′] Scherpereel K L, Molinaro D D, Shepherd M K, Inan O T, Young A J. Improving Biological Joint Moment Estimation During Real-World Tasks with EMG and Instrumented Insoles. IEEE Transactions on Biomedical Engineering. Published online 2024.
[66′] Halilaj E, Rajagopal A, Fiterau M, Hicks J L, Hastie T J, Delp SL. Machine learning in human movement biomechanics: Best practices, common pitfalls, and new opportunities. Journal of biomechanics. 2018; 81:1-11.
[67′] Moore D S. The Basic Practice of Statistics. 5th ed. W. H. Freeman and Company; 2010.
[68′] Stetter B J, Ringhof S, Krafft F C, Sell S, Stein T. Estimation of knee joint forces in sport movements using wearable sensors and machine learning. Sensors. 2019; 19(17):3690.
[69′] Stetter B J, Ringhof S, Krafft F C, Sell S, Stein T. Estimation of knee joint forces in sport movements using wearable sensors and machine learning. Sensors. 2019; 19(17):3690.
[70′] Giarmatzis G, Zacharaki E I, Moustakas K. Real-Time Prediction of Joint Forces by Motion Capture and Machine Learning. Sensors. 2020; 20(23):6933. doi: 10.3390/s20236933
[71′] De Brabandere A, Emmerzaal J, Timmermans A, Jonkers I, Vanwanseele B, Davis J. A machine learning approach to estimate hip and knee joint loading using a mobile phone-embedded IMU. Frontiers in bioengineering and biotechnology. 2020; 8:320.
[72′] Fregly B J, Besier T F, Lloyd D G, et al. Grand challenge competition to predict in vivo knee loads. Journal Orthopaedic Research. 2012; 30(4):503-513. doi: 10.1002/jor.22023
[73′] Bernard T_{M}, Ayoub M M, Lin C J. Evaluation of a biomechanical simulation model for sagittal plane lifting. International Journal of Industrial Ergonomics. 1999; 24(2):157-171. doi: 10.1016/S0169-8141(98)00011-0
[74′] Lin C J, Ayoub M M, Bernard T_{M}. Computer motion simulation for sagittal plane lifting activities. International Journal of Industrial Ergonomics. 1999; 24(2):141-155. doi: 10.1016/S0169-8141(98)00010-9
[75′] Beaucage-Gauvreau E, Robertson W S P, Brandon S C E, et al. Validation of an OpenSim full-body model with detailed lumbar spine for estimating lower lumbar spine loads during symmetric and asymmetric lifting tasks. Computer Methods in Biomechanics and Biomedical Engineering. 2019; 22(5):451-464. doi: 10.1080/10255842.2018.1564819
[76′] Delp S L, Anderson F C, Arnold A S, et al. OpenSim: Open-Source Software to Create and Analyze Dynamic Simulations of Movement. IEEE Trans Biomed Eng. 2007; 54(11):1940-1950. doi: 10.1109/TBME.2007.901024
[77′] Bedo B L S, Catelli D S, Lamontagne M, Santiago P R P. A custom musculoskeletal model for estimation of medial and lateral tibiofemoral contact forces during tasks with high knee and hip flexions. Computer Methods in Biomechanics and Biomedical Engineering. 2020; 23(10):658-663. doi: 10.1080/10255842.2020.1757662
[78′] Garg A, Chaffin D B, Freivalds A. Biomechanical Stresses From Manual Load Lifting: A Static vs Dynamic Evaluation. A I I E Transactions. 1982; 14(4):272-281. doi: 10.1080/05695558208975240
[79′] Cholewicki J, McGill S M, Norman R W. Comparison of muscle forces and joint load from an optimization and EMG assisted lumbar spine model: Towards development of a hybrid approach. Journal of Biomechanics. 1995; 28(3):321-331. doi: 10.1016/0021-9290(94)00065-C
[80′] Pizzolato C, Lloyd D G, Sartori M, et al. CEINMS: A toolbox to investigate the influence of different neural control solutions on the prediction of muscle excitation and joint moments during dynamic motor tasks. Journal of Biomechanics. 2015; 48(14):3929-3936. doi: 10.1016/j.jbiomech.2015.09.021
[81′] Hoang H X, Diamond L E, Lloyd D G, Pizzolato C. A calibrated EMG-informed neuromusculoskeletal model can appropriately account for muscle co-contraction in the estimation of hip joint contact forces in people with hip osteoarthritis. Journal of Biomechanics. 2019; 83:134-142. doi: 10.1016/j.jbiomech.2018.11.042
[82′] Uhlrich S D, Jackson R W, Seth A, Kolesar J A, Delp SL. Muscle coordination retraining inspired by musculoskeletal simulations reduces knee contact force. Sci Rep. 2022; 12(1):9842. doi: 10.1038/s41598-022-13386-9
[83′] McCain E M, Dalman M J, Berno M E, et al. The influence of induced gait asymmetry on joint reaction forces. Journal of Biomechanics. 2023; 153:111581. doi: 10.1016/j.jbiomech.2023.111581
[84′] Ostaszewski M, Pauk J. Estimation of ground reaction forces and joint moments on the basis on plantar pressure insoles and wearable sensors for joint angle measurement. Technology and Health Care. 2018; 26(S2):605-612.
[85′] Mehrizi R, Peng X, Metaxas D N, Xu X, Zhang S, Li K. Predicting 3-D lower back joint load in lifting: A deep pose estimation approach. IEEE Transactions on Human-Machine Systems. 2019; 49(1):85-94.
[86′] Jensen R L. Relationship of ground reaction and knee joint reaction forces in plyometric exercises. Published online 2010.
[87′] Burton II W S, Myers C A, Rullkoetter P J. Machine learning for rapid estimation of lower extremity muscle and joint loading during activities of daily living. Journal of Biomechanics. 2021; 123:110439.
[88′] Elstub L, Nurse C, Grohowski L, Volgyesi P, Wolf D, Zelik K. Tibial bone forces can be monitored using shoe-worn wearable sensors during running. Journal of sports sciences. 2022; 40(15):1741-1749.
[89′] Nurse C A, Elstub L J, Volgyesi P, Zelik K E. How accurately can wearable sensors assess low back disorder risks during material handling? Exploring the fundamental capabilities and limitations of different sensor signals. Sensors. 2023; 23(4):2064.
[90′] Conforti I, Mileti I, Del Prete Z, Palermo E. Measuring biomechanical risk in lifting load tasks through wearable system and machine-learning approach. Sensors. 2020; 20(6):1557.
[91′] Davenport F R, Leestma J K, Staten A, et al. EMG-informed estimates of joint contact forces within the lower-back and knee joints during a diverse set of industry-relevant manual lifting tasks. Journal of Applied Biomechanics. Published online In Review.
[92′] McDevitt S, Hernandez H, Hicks J, et al. Wearables for biomechanical performance optimization and risk assessment in industrial and sports applications. Bioengineering. 2022; 9(1):33.
[93′] Winter D A, Yack H. EMG profiles during normal human walking: stride-to-stride and inter-subject variability. Electroencephalography and clinical neurophysiology. 1987; 67(5):402-411.

1. A system comprising:
a bodysuit configured to wrap around and conform to a body region of a user, the bodysuit being instrumented with a plurality of body-conformable sensors fixably attached to the bodysuit to provide a conformable sensor fit, including (i) a first body-conformable sensor configured to be placed at a first non-joint body appendage and (ii) a second body-conformable sensor configured to be placed at a second non-joint body appendage, for control of a wearable robot suit or exoskeleton suit; and
a controller comprising:
a processor;
a memory having instructions stored thereon, wherein execution of the instructions by the processor causes the processor to:
receive, via the processor, body-conformable sensor data measurements acquired from the plurality of body-conformable sensors;
determine, via a trained deep-learning model, internal physiological state estimates, internal physical state estimates, or a combination thereof using the body-conformable sensor data measurements, including the body-conformable sensor data measurements of the first body-conformable sensor and the second body-conformable sensor, as input to the trained deep-learning model, wherein the internal physiological state estimates, the internal physical state estimates, or the combination thereof are directed to (i) a joint region of the body region located between the first non-joint body appendage and the second non-joint body appendage and (ii) include joint kinematics, segment kinematics, joint moments, joint powers, joint mechanical work, and a combination thereof, and wherein the trained deep-learning model was configured during training using the body-conformable sensor data measurements labeled with the internal physiological state estimates, the internal physical state estimates, or the combination thereof derived from training data; and
output, via the processor, the internal physiological state estimates, the internal physical state estimates, or the combination thereof, wherein the output internal physiological state estimates, the output internal physical state estimates, or the output combination thereof for use in controls of the wearable robot suit or exoskeleton suit.

2. (canceled)

3. The system of claim 1, wherein the internal physiological state estimates include muscle physiological states selected from the group consisting of muscle length/velocity, muscle force, muscle applied torque, muscle power, and a combination thereof.

4. The system of claim 1, wherein the internal physiological state estimates include internal-joint-loading physiological states selected from the group consisting of bone-on-bone contact force, shear forces at joints, and a combination thereof.

5. The system of claim 1, wherein the internal physical state estimates include ground reaction forces made by feet or hands making mechanical contact with a surface.

6. The system of claim 1, wherein the trained deep-learning model was configured during training using a plurality of body-conformable sensor data measurements acquired using:
(i) body-conformable sensors located, on a training system, at a set of body segments proximal to a set of joints labeled with joint physiological states,
(ii) body-conformable sensors located, on the training system, at a set of body segments proximal to or at a set of muscles labeled with muscle physiological states,
(iii) body-conformable sensors located, on the training system, at a set of body segments proximal to or at a set of joints labeled with internal-joint-loading physiological states, or
(iv) a combination thereof,
wherein the trained deep-learning model was configured during training during plurality of body-conformable sensor data measurements acquired for a plurality of cyclic activities and non-cyclic activities for a set of people.

7. The system of claim 6, wherein the trained deep-learning model was additionally configured during training using virtual measurements, as training data, of external environmental sensor measurements acquired, on the training system, at a set of feet labeled with physical states for the plurality of cyclic and non-cyclic human activities performed by the set of people.

8. The system of claim 1, wherein each body-conformable sensor of the plurality of body-conformable sensors is an inertial measurement unit (i) configured to be placed at a region of a body appendage or muscle and (ii) configured to generate acceleration data measurements, angular velocity data measurements, orientation data measurements, or a combination thereof acquired at the region of the body appendage or muscle.

9. The system of claim 1, wherein the trained deep-learning model was configured during training using acceleration data measurements, angular velocity data measurements, orientation data measurements, or a combination thereof acquired at a region of the body appendage or muscle of a person, wherein each conformable sensor of the plurality of body-conformable sensors is an accelerometer (i) placed at the region of the body appendage or muscle of the person.

10. The system of claim 1, wherein each mechanical sensor includes a gyroscope (i) configured to be placed at a region of a body appendage or muscle and (ii) configured to generate the body-conformable sensor data measurements comprising acceleration data measurements, angular velocity data measurements, orientation data measurements, or a combination thereof acquired at the region of the body appendage or muscle.

11. The system of claim 1, wherein the bodysuit is configured to cover a lower-body region of the user, including at least one leg, a thigh, a pelvic region, and a knee, as the body region of the user.

12. The system of claim 1, wherein the bodysuit is configured to cover upper-body parts, including at least one arm, an elbow, and chest, as the body region of the user.

13. The system of claim 1 further comprising:
a set of pressure sensors configured to generate surface reaction force data measurements, center-of-pressure measurements, or a combination thereof acquired from feet, hands, or fingers.

14. The system of claim 13, wherein execution of the instructions by the processor further causes the processor to:
determine, via the trained deep-learning model, the internal physiological state estimates, the internal physical state estimates, or the combination thereof using, in addition to the body-conformable sensor data measurements, the surface reaction force data measurements, the center-of-pressure measurements, or the combination thereof as input to the trained deep-learning model.

15. The system of claim 1, wherein the internal physiological state estimates, the internal physical state estimates, or the combination thereof is subsequently employed for health or safety-related monitoring of activities or tasks performed by the user.

16. The system of claim 1, wherein the internal physiological state estimates, the internal physical state estimates, or the combination thereof is subsequently employed for generating biofeedback reports or alerts for activities performed by the user.

17. (canceled)

18. The system of claim 1, wherein the controller is implemented in a backpack comprising:
a battery; and
a plurality of cable channels configured to provide wired connections between the body-conformable sensors and the controller.

19. The system of claim 1, wherein the controller is implemented in a mobile device comprising a network interface configured to communicate with the body-conformable sensors through a network.

20. The system of claim 1, wherein the controller is a remote computing device located in a cloud infrastructure comprising a network interface configured to communicatively operate with the body-conformable sensors through a network.

21. The system of claim 1, wherein the trained deep-learning model is a temporal neural network.

22. The system of claim 7, wherein the cyclic and non-cyclic human activities include a plurality of motions selected from the group consisting of walking, standing, pushing, pulling, shoveling, turning, cutting, sitting, jumping, ball tossing, lifting a weight, stepping up, and climbing stairs, and wherein each cyclic and non-cyclic human activity is performed at different configurations.

23. A method comprising:
providing a bodysuit configured to wrap around and conform to a body region of a user, the bodysuit being instrumented with a plurality of body-conformable sensors fixably attached to the bodysuit to provide a conformable sensor fit, including (i) a first body-conformable sensor configured to be placed at a first non-joint body appendage and (ii) a second body-conformable sensor configured to be placed at a second non-joint body appendage, for control of a wearable robot suit or exoskeleton suit;
receiving, via a processor, sensor data measurements acquired from the plurality of body-conformable sensors placed at the first and second non-joint body appendages of the user;
determining, via a trained deep-learning model, internal physiological state estimates, internal physical state estimates, or a combination thereof using the sensor data measurements, including the body-conformable sensor data measurements of the first body-conformable sensor and the second body-conformable sensor, as input to the trained deep-learning model, wherein the internal physiological state estimates, the internal physical state estimates, or the combination thereof are directed to (i) a joint region of the body region located between the first non-joint body appendage and the second non-joint body appendage and (ii) include joint kinematics, segment kinematics, joint moments, joint powers, joint mechanical work, and a combination thereof, and wherein the trained deep-learning model was trained configured during training using the body-conformable sensor data measurements labeled with the internal physiological state estimates, the internal physical state estimates, or the combination thereof of training data; and
outputting, via the processor, the internal physiological state estimates, the internal physical state estimates, or the combination thereof, for controls of the wearable robot suit or exoskeleton suit.

24. A non-transitory computer readable medium having instructions stored thereon, wherein execution of the instructions by a processor causes the processor to:
receive sensor data measurements acquired from a plurality of body-conformable sensors placed at a plurality of non-joint body appendages of a user, wherein the sensor data measurements are acquired via a bodysuit configured to wrap around and conform to a body region of the user, the bodysuit being instrumented with the plurality of body-conformable sensors fixably attached to the bodysuit to provide a conformable sensor fit, including (i) a first body-conformable sensor configured to be placed at a first non-joint body appendage and (ii) a second body-conformable sensor configured to be placed at a second non-joint body appendage, for control of a wearable robot suit or exoskeleton suit;
determine, via a trained deep-learning model, internal physiological state estimates, internal physical state estimates, or a combination thereof using the sensor data measurements, including the body-conformable sensor data measurements of the first body-conformable sensor and the second body-conformable sensor, as input to the trained deep-learning model, wherein the internal physiological state estimates, the internal physical state estimates, or the combination thereof are directed to (i) a joint region of the body region located between the first non-joint body appendage and the second non-joint body appendage and include joint kinematics, segment kinematics, joint moments, joint powers, joint mechanical work, and a combination thereof, and wherein the trained deep-learning model was configured during training using the body-conformable sensor data measurements labeled with the internal physiological state estimates, the internal physical state estimates, or the combination thereof; and
output the internal physiological state estimates, the internal physical state estimates, or the combination thereof for controls of the wearable robot suit or exoskeleton suit.

25. The system of claim 1, wherein the plurality of body-conformable sensors is woven or stitched to the bodysuit to be fixably attached to the bodysuit.
